(19) United States
(12) Patent Application Publication
(10) Pub. No.: US 2013/0181975 A1
(43) Pub. Date: Jul. 18, 2013

(54) SYSTEMS AND METHODS FOR OBJECTS ASSOCIATED WITH A THREE-DIMENSIONAL MODEL

(71) Applicants: Aaron Eliezer Golden, San Francisco, CA (US); Peter S. Cho, San Francisco, CA (US); Chatree Campiranon, Mountain View, CA (US); Kenneth Lorenz Knowles, Berkeley, CA (US)

(72) Inventors: Aaron Eliezer Golden, San Francisco, CA (US); Peter S. Cho, San Francisco, CA (US); Chatree Campiranon, Mountain View, CA (US); Jonathan Wight, Emeryville, CA (US); Kenneth Lorenz Knowles, Berkeley, CA (US)

(73) Assignee: Standard Nine Inc. (dba Inkling), San Francisco, CA (US)

(21) Appl. No.: 13/353,288

(22) Filed: Jan. 18, 2012

(51) Int. Cl. G06T 15/00

(52) U.S. Cl. 345/419

(57) ABSTRACT

A system, computer-readable storage medium, and a computer-implemented method for associating two-dimensional objects with a three-dimensional model are presented. A three-dimensional model is rendered using a graphics API from a first position to a second position on a display of a user device in response to a user input and is associated with a two-dimensional object previously displayed, using native controls, in the first position prior to the user input. A first set of three-dimensional coordinates associated with the two-dimensional object in the first position is determined and transformed via the graphics API to a second set of three-dimensional coordinates associated with the two-dimensional object in the second position based on the user input. The two-dimensional object is displayed in the second position based on the second set of three-dimensional coordinates via the native controls.

### COPY RIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011, Standard Nine Inc. (d.b.a. Inkling), All Rights Reserved.

### BACKGROUND

As the use of personal computing devices to read or view content becomes more commonplace, the manner in which content is provided has varied. For example, in the context of learning tools, content may include interactive content such as figures or images as a guide to the material being provided. These figures or images may include annotations explaining details about a typical aspect of a figure or image. For example, an annotation may include a tag pointing to a particular aspect of a figure, wherein the tag acts as a caption explaining the particular aspect to which the tag points. Other examples of annotations may include interactive buttons or control objects which may provide additional information to the user.

Other types of content may include three-dimensional models that a user may rotate to view different perspectives of the model. Typically, three-dimensional models may be rendered using three-dimensional rendering software. Examples of low-level three-dimensional application programming interfaces (APIs) include Open Graphics Library (OpenGL), X3D, Direct3D, RenderMan, etc. These three-dimensional rendering tools may provide a user with the ability to create a three-dimensional model, provide the layout and animation for the three-dimensional model, and render the three-dimensional model for display as a two-dimensional object on a display screen.

While providing three-dimensional models to a user may be helpful in depicting a particular object in detail, associating a three-dimensional model with a two-dimensional object, such as an annotation, must typically be performed using a three-dimensional rendering tool. For example, a content creator may wish to provide annotations to a three-dimensional model in order to explain particular aspects of the three-dimensional model. Typically, in order to associate an annotation with a particular location on a three-dimensional model, the annotation must be rendered as a three-dimensional object as well an that the annotation may rotate with the three-dimensional model as it is rotated by a user. However, rendering an annotation as a three-dimensional object requires the use of three-dimensional rendering software, which does not provide functionality beyond the three-dimensional rendering.

### SUMMARY

Disclosed in some examples are a system, computer-implemented storage medium storing at least one program, and a computer-implemented method for associating two-dimensional Objects with a three-dimensional model. A three-dimensional model is rendered using a graphics API via one or more processors. The three-dimensional model is rendered from a first position to a second position on a display of a user device in response to a user input and is associated with a two-dimensional object previously displayed, using native controls via the one or more processors, in the first position prior to the user input. A first set of three-dimensional coordinates associated with the two-dimensional object in the first position is determined. The first set of three-dimensional coordinates associated with the two-dimensional object in the first position are transformed via the graphics API to a second set of three-dimensional coordinates associated with the two-dimensional object in the second position based on the user input. The two-dimensional object is displayed in the second position based on the second set of three-dimensional coordinates via the native controls.

These examples may be combined in any permutation or combination. This overview is intended to provide an overview of subject matter of the present patent application. It is not intended to provide an exclusive or exhaustive explanation of the embodiments of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a system according to some examples of the present disclosure.

FIG. 2 shows a media card according to some examples of the present disclosure.

FIG. 3 shows an electronic bookstore according to some examples of the present disclosure.

FIG. 4 shows a home screen according to some examples of the present disclosure.

FIG. 5 shows an example of a navigation type according to some examples of the present disclosure.

FIG. 6 is a block diagram illustrating an execution environment according to some examples of the present disclosure.

FIG. 7 is a flow chart showing an example method of the execution environment according to some examples of the present disclosure.

FIG. 8 shows a block diagram of an example electronic reader according to some examples of the present disclosure.

FIG. 9 shows a block diagram of an example interactive service according to some examples of the present disclosure.

FIG. 10 is a flow chart showing an example method of rendering a three-dimensional model associated with a two-dimensional object according to some examples of the present disclosure.

FIGS. 11(a)-(f) show example views of a three-dimensional model associated with a two-dimensional object according to some examples of the present disclosure.

FIG. 12 is a flow chart showing an example method of placing a two-dimensional object on a particular location on the three-dimensional model according to some examples of the present disclosure.

FIG. 13 is a flow chart showing an example method of creating a condensed vertex buffer according to some examples of the present disclosure.

FIG. 14 shows an example computing system according to some examples of the present disclosure.

### DETAILED DESCRIPTION

Disclosed are systems and methods for objects associated with a three-dimensional (3D) model. A content service may provide content created by authors to a user's personal computing device, such as an electronic book by an author, for example. In some instances, authors may include content such as figures, models, images, etc. as part of the electronic book in order to supplement the material in the electronic book. The content may also include interactive 3D models that can be moved and positioned by a user in any manner (e.g., rotated, scaled up or down, etc.). For example, a user may use a pointing device to drag and rotate or scale a. 3D model to a different perspective. In other examples where the user device includes a touch-screen display, a user may drag and rotate or scale a 3D model using the touch-screen. These 3D models may provide different perspectives of the model, providing the user with a more detailed depiction of the model. For example, if the electronic book were a biology textbook, the electronic book may include a 3D model of a human heart that is rotatable to depict the different elements of a human heart. Typically, 3D models may be rendered using three-dimensional rendering software, such as a low-level graphics application programming interface (API). A low-level graphics API may be any set of functions that may be used to display and manipulate graphics primitives (e.g., pixels, vectors, color space, etc.). Low-level graphics APIs may include functions for drawing points, lines, triangles, and other shapes, and manipulating vertices in 3D space. Examples of low-level three-dimensional APIs include Open Graphics Library (OpenGL), X3D, Direct3D, RenderMan, etc. These three-dimensional rendering tools may provide a user with the ability to create a three-dimensional model, provide the layout and animation for the three-dimensional model., and render the three-dimensional model for display as a two-dimensional object on a display screen.

The content of an electronic book may further include annotation objects, which may provide a user with a more detailed explanation of a particular aspect of the content. For example, an image may be enhanced with an annotation object anchored at any point on the image. The annotation object may be a context-sensitive annotation of content that, when selected, presents additional content related to the image or other content in a container overlaid over a portion of the content. The annotation object is typically a two-dimensional (2D) object that may be rendered on a display of a user device using controls that are native to the operating system of the user device on which the annotation object is displayed. The 2D object may be anchored to a particular point on an image or figure to provide further explanation about a particular aspect at that point on the image or figure. The 2D object may include text, buttons, hyperlinks, interactive objects, or any other control objects that may be provided for additional content to the user.

The 2D annotation objects may be anchored to a particular location on a 3D object to provide additional information about the 3D model at that particular location. For example, if a 3D model depicted a human heart, a 2D annotation object may be anchored to the left ventricle displayed on the 3D model, and the 2D annotation object may contain additional information about the left ventricle. When the user rotates or scales the 3D model of the human heart, the 2D annotation object may move with the 3D model as if anchored to the left ventricle. In order to give the appearance that a 2D annotation object is anchored to a particular location on a 3D model, instead of rendering the 2D object using a 3D object library, the 2D object may be anchored to a particular location on the 3D model while maintaining its native controls. When a 3D model is rendered on a display in response to a user input (e.g., rotated, scaled, etc.), the 3D model undergoes a model transform using a graphics API to transform the model based on the user's input. A projection transform is then performed using the graphics API, which projects the transformed model transform into a unit cube. The projection transform is then rasterized using the graphics API, which takes the unit cube model and renders the model onto a 2D surface (e.g., a computer screen). After the 3D model is rendered, the 2D object may undergo a similar model transform and projection transform using the graphics API. However, instead of being rasterized, the 2D coordinates for displaying the 2D object are determined from the projection transform, and the 2D object can then be displayed using the determined 2D coordinates via native controls. Because the 2D object is displayed using native controls instead of the graphics API, the 2D object may maintain native behaviors, including behaviors of the content within the 2D object (e.g., text, buttons, hyperlinks, interactive objects, etc.).

The 2D object may have additional features that give the appearance that the 2D object is anchored to the 3D model. For example, if the user rotates the 3D model such that a 2D object is moved to the back of the perspective shown for the 3D model, the 2D object may be displayed in a manner which indicates that the 2D object is on the back of the 3D model. For example, the 2D object may be displayed in a faded manner to indicate that it is in the background. Additionally, to optimize the display space, the 2D object may adjust its position when a user rotates or scales the 3D model, or if the user expands the 2D object.

In some embodiments, a content creator may wish to modify an existing 3D model by adding an additional 2D annotation object. A content creator may indicate a particular x-y location on the 2D screen at which the content creator wishes to place a 2D annotation object. In response, the content service may access z-coordinate data associated with the 3D model and determine a z-coordinate associated with that particular x-y location. The determined z-coordinate may be associated with that particular x-y location, and the 2D object can be generated and displayed based on the z-coordinate and the x-y coordinate of the particular location.

Typically, a 3D model may be described in a human-readable format. The model description may contain vertex information for all vertices of the 3D model and information about how the vertices are connected. The model description may contain additional human-readable information about the 3D model. Because human-readable descriptions of typical models can be rather large, a smaller vertex buffer can be generated from the human readable format and used by the software to represent the 3D model. To create a smaller vertex buffer, the original model description may be parsed to obtain information to render the 3D model (e.g., vertices, information about how the vertices are connected, etc.), leaving out arty extraneous data. The resulting smaller vertex buffer may include this subset of data from the original model description and may be used to render the 3D model.

While the present disclosure may describe certain operations with respect to electronic books, these operations are equally applicable to other types of media, including electronic pamphlets, magazines, video games, newspapers, study aids, practice questions, or the like, as well as electronic books. It should also be appreciated that those operations are equally applicable to portions of those materials.

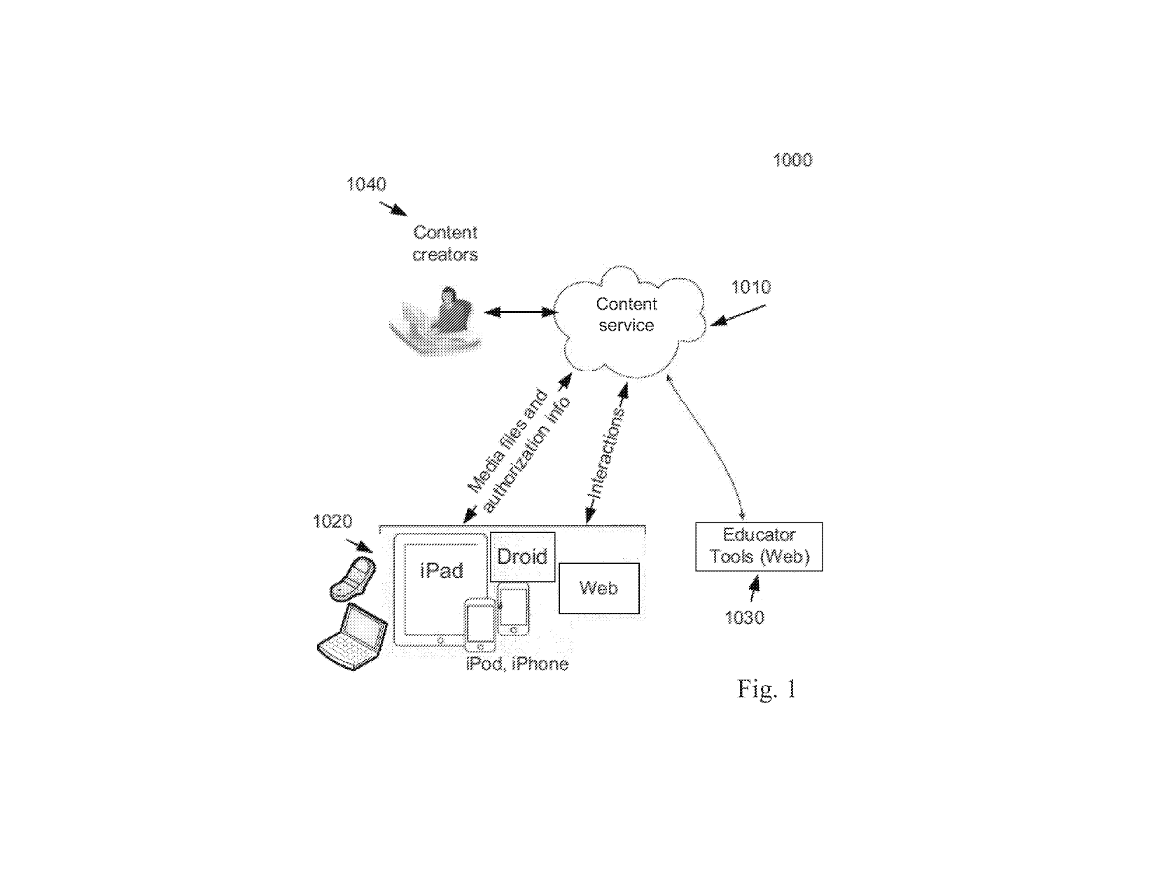

FIG. 1 shows a system 1000, according to sonic examples, including a content service 1010, electronic reader devices 1020, educator tools 1030, and content creators 1040.

The content service 1010 receives content from content creators 1040 and transforms the content in the content ingestion processes to a platform-independent digital specification. In some examples, the content may be an electronic book. This representation is then placed in storage where users running an execution environment on the reader devices 1020 may download or otherwise access these media files. Additionally, authorization information for users and/or electronic reader devices 1020 may be transferred between the content service 1010 and the electronic reader devices 1020. The electronic reader devices 1020 present the content to the users of the electronic reader devices 1020. Users may then interact with the content on the electronic reader devices 1020 and also with other users of the content through social networking applications running in the content service 1010.

### Electronic Book

In some examples, an electronic book may contain content presentation objects including but not limited to images, graphics, figures, 3D models, audio, text, video, interactive content presentation objects, interactive assessment objects, and any other contents that a content creator may choose to include in an electronic book. An interactive content presentation object may be any information and/or experiences presented by the electronic reader to an end-user that allows for user interaction. An interactive assessment object is any information and/or experiences presented by the electronic reader to an end-user to assess their knowledge (e.g., of or about content provided as part of an interactive content presentation object). In some examples, an interactive assessment object is an object that, when presented by an electronic reader, presents a question or series of questions along with audio, video, audio-video, text, graphics, and/or the like to test a user's knowledge of a part of the book, or other content. Types of interactive assessments include, but are not limited to: multiple choice, matching, reordering, audio-based assessments, and the like.

User interactions may be any user action that acts on, with, or about the interactive content presentation objects or interactive assessment objects. User interactions may include, in some examples, user bookmarks of certain locations in the book, user comments, notes, or questions left at a certain point of the book, user highlighting of the book, user quoting of the book, user manipulation of the various interactive elements of the interactive content presentation or assessment objects such as zooming, panning, and rotating graphics, and the like. In some examples, the interactivity may be social so that other users viewing the interactive content presentation object may see at least a portion of another user's interactions. Thus, for example, a user may leave a note or question that some, or all, of the individuals also viewing that content presentation may see, read, answer, or react to. In other examples, the user may leave a note to an instructor, who may respond. In still other examples, an individual may share a bookmark indicating the current user's reading location to other users.

In some embodiments, an electronic book may be represented in a platform independent way, which is then executed by execution environments on various heterogeneous devices to produce a visually consistent presentation of contents. The contents may be presented using locally available application programming interfaces such that the user interface style matches that of the device. Thus, for example, when the book is executed on a Windows™ device, it will appear to match the Windows™ style, but on an iOS™ device such as an iPad™, will match the iOS™ look and feel. Windows™ is an operating system developed by Microsoft™, Inc, of Redmond, Wash. iOS™ is a different operating system developed by Apple™, Inc. of Cupertino, Calif.

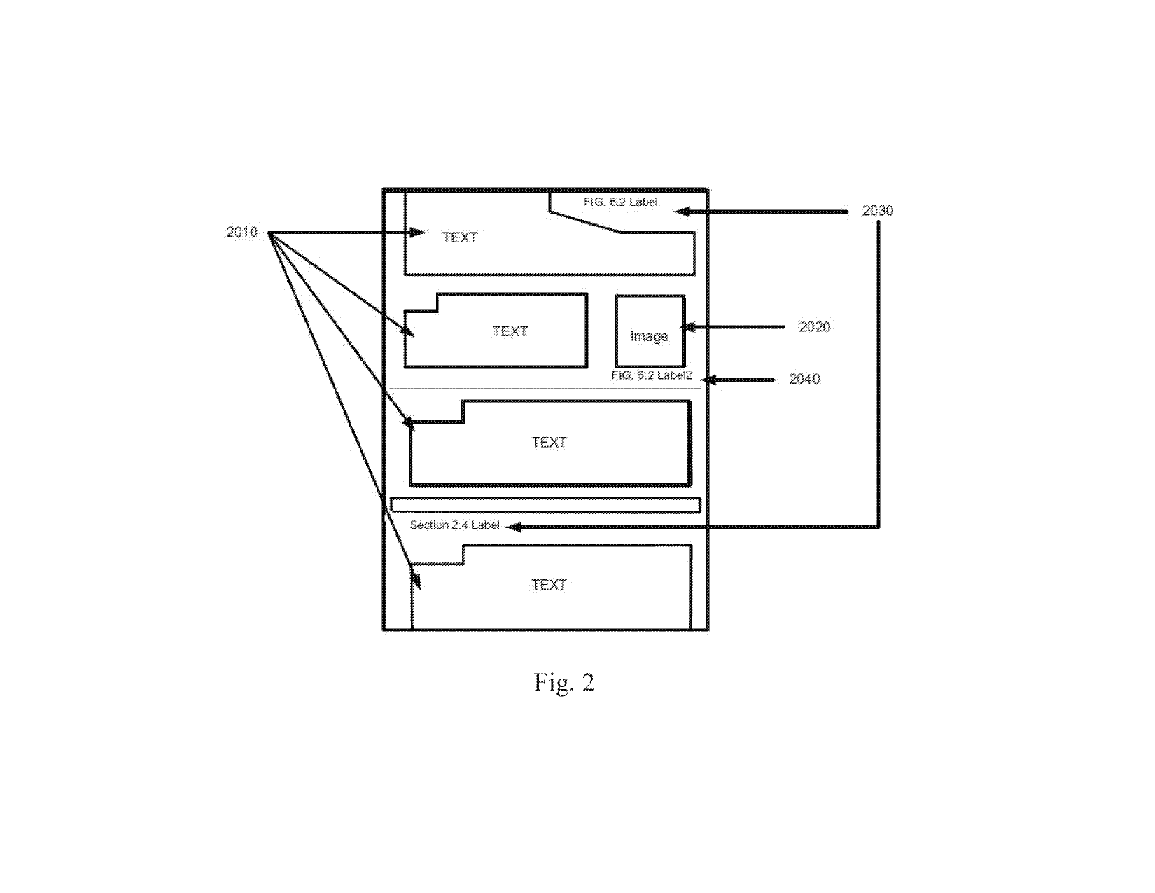

The electronic books and the constituent content presentation objects may be created by content authors using digital content templates. Content templates, or blueprints, consist of a number of standardized content presentation formats, or shells, which authors use as a basis for producing the various content presentation objects. In some examples, only content presentation objects created with a content blueprint will be valid content recognized by the execution environment. This may be to ensure that the content is properly handled, recognized, and displayed by the various execution environments running on the different types of electronic readers. In some examples, the blueprint may be an extensible markup language (XML) file, a hypertext markup language HTML) or the like. Once a blueprint is instantiated, it may be called a “media card.” An example abstraction of a media card is shown in FIG. 2 which shows one or more text sections 2010 and one or more image sections 2020 along with header sections 2030 and image caption 2040 arranged in a desired order.

In some examples, white the various blueprints are described in a platform-agnostic manner, the various media cards formed from those blueprints may be displayed differently depending on the electronic reader platform. This is because different devices may have different capabilities. For example, an iPhone™ may not be able to display the same image resolution as an iPad™. Therefore, in some examples, the image, video, audio, or other media may be adjusted depending on the device capabilities. Device capabilities that may impact the presentation layout may include screen size, screen resolution, video capabilities, audio capabilities, and the like. As a result of these differences, the layout of the card may be impacted. Therefore, in some examples, the blueprints and associated media (such as images) may be processed in the content service such that even if the two different reader devices have different capabilities (for example, the image capabilities of the two devices are different), the blueprints and the associated media objects are adjusted for that platform to display everything in a visually consistent manner that is platform appropriate. Thus, for example, the images, the interactions, the layouts, and the like are displayed in the right locations, in a platform appropriate manner and according to the capabilities of the device. The platform appropriate manner refers to the look and feel of the user interface elements of the reader. Thus the electronic book will have an iOS™ look and feel on an iPad™, but a Windows™ look and feel on a Windows™ device. Thus, for example, even though an image may be in a different place, with different resolutions, the interactions with that image and the layout appear consistent—e.g., in the correct place and in a user-friendly manner.

The content service system may be aware of the characteristics of a given target device, such as its display size, the pixel density of the display, its aspect ratio, whether it supports touch-based input, how much memory is available to the application, and other characteristics. The system may pre-process data for a given target device. For example, for low-resolution displays, or for systems with limited amounts of runtime memory available to the application, tower resolution versions of the data may be sent to the device. Furthermore, if a device lacks touch-based input support, a mouse-and-keyboard based interface may be presented to the user. If devices have high-density, pixel displays, such as Apple®, Inc's “Retina Display,” images and icons can be displayed at a higher resolution than devices that lack such pixel density. The system may make modifications to the data before sending to the device, or the device may interpret the data differently at runtime. In both cases, the platform independent representation of the content being displayed is the same.

Some example content blueprints may include a table of contents blueprint for displaying the electronic book's table of contents, a reader blueprint for text and graphics, an image figure blueprint, a multi-image figure (or slideshow) blueprint, a guided tour blueprint, a test-yourself blueprint, a sideline™ blueprint, video blueprint, glossary blueprints, and assessment blueprints. Blueprints may contain links to other media files such as images, videos, audio, and the like to complete the presentation.

The table of contents blueprint of an electronic book represents the organization of the overall title and describes how the rest of the media cards in the title are structured. In some examples, this may take the form of a tree structure with the table of contents card being the root node. In some examples, the other media cards may be organized into chapters and all chapters may be organized into units, and so on. Each chapter may consist of primary cards (generally reading cards that correspond with sections from the main text) and embedded cards (image figures and other reading cards that are linked to from the primary cards). Embedded cards may be included as children of the parent card in the table of contents card. Other linear and non-linear structures may be represented depending on the application. The table of contents blueprint may be platform-agnostic, as already explained; however, both the various included media and the blueprint may be adjusted by the content service to adjust for different device characteristics. Thus, for example, even if the media capabilities of two different devices are different, the blueprint will be adjusted for each platform so that the layout is correct across both devices.

Cards created from the blueprints may contain one or more links to other cards and other content including other reader cards, other image figure cards, etc. In some examples, the electronic book presented on the electronic reader device does not need to be linearly organized into the traditional book concepts of chapter, section, page, etc. In some examples, other links take users to a glossary, more in-depth coverage of a topic, or manipulable images which allow a user to zoom, rotate, or pan. In some examples, the table of contents contains links to all other cards in the book.

### Execution Environment and Electronic Reader

The execution environment takes the platform-independent digital specification and the media and presents it to the user. The execution environment allows for user interactions with the presented content. As used herein, the term “present” includes at least the displaying or playing of audio, visual, and audio-visual content. The content includes text, graphics, images, 3D models, video, sounds as well as the manipulation of and interaction with that content by an end user.

In some examples, the execution environment also connects to the content service and requests a web page or listing of available electronic books to download or otherwise authorize. In some examples, this functionality may include an electronic book or media marketplace where such media is available for purchase. The store may include search capabilities, personal recommendations, user ratings, and other features. In some examples, the store may present a list of the required textbooks for courses in which a user is enrolled. Each item may also show related content such as supplements and other learning aids related to the electronic book. In some examples, purchases may be made with a credit card, with or without a user opening an account with the store. In other examples, the store accounts may be linked with, or use, other accounts, such as an iTunes account run by Apple, Inc., or an Amazon.com account. These accounts may save user purchasing information.

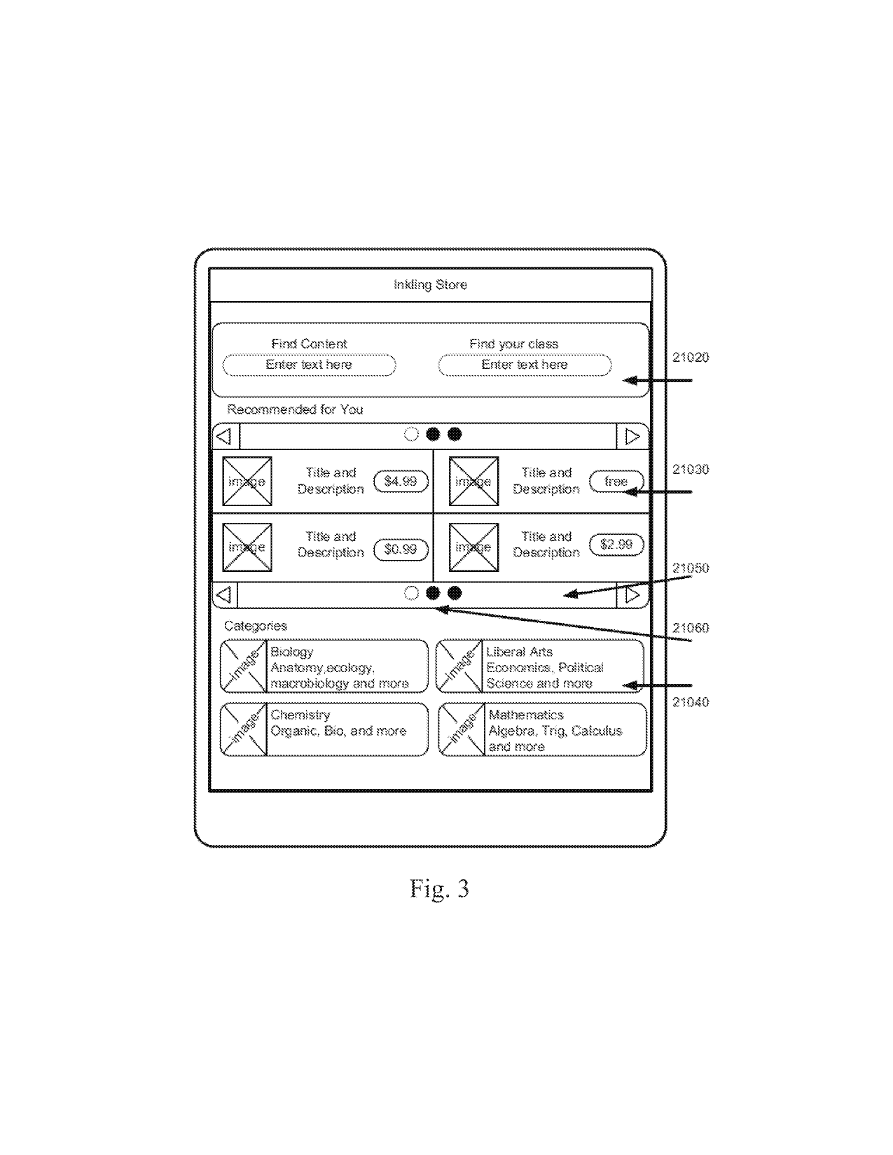

In some examples, the store may be an online merchant store residing on the content service. In other examples, the store may be an application on the electronic reader where the application communicates with the server infrastructure to ascertain the server's current inventory. In still other examples, the store is run by a third-party server such as iTunes, or the App store. One example store is shown in FIG. 3. Reference numeral 21020 shows a header with search boxes. Reference numeral 21030 shows personalized recommendations, and reference numeral 21040 shows various categories of electronic books. Various navigation elements such as scrollbars 21050 and page indicators 21060 are also shown.

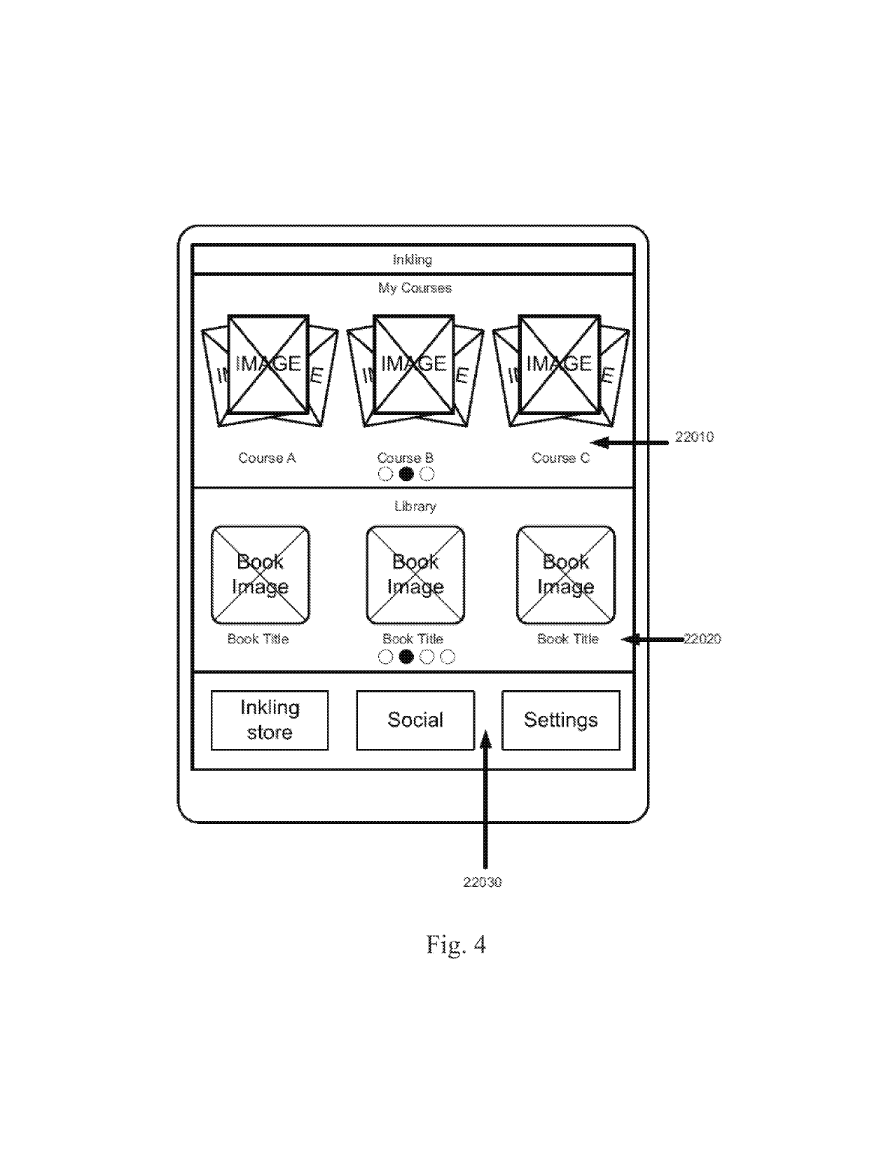

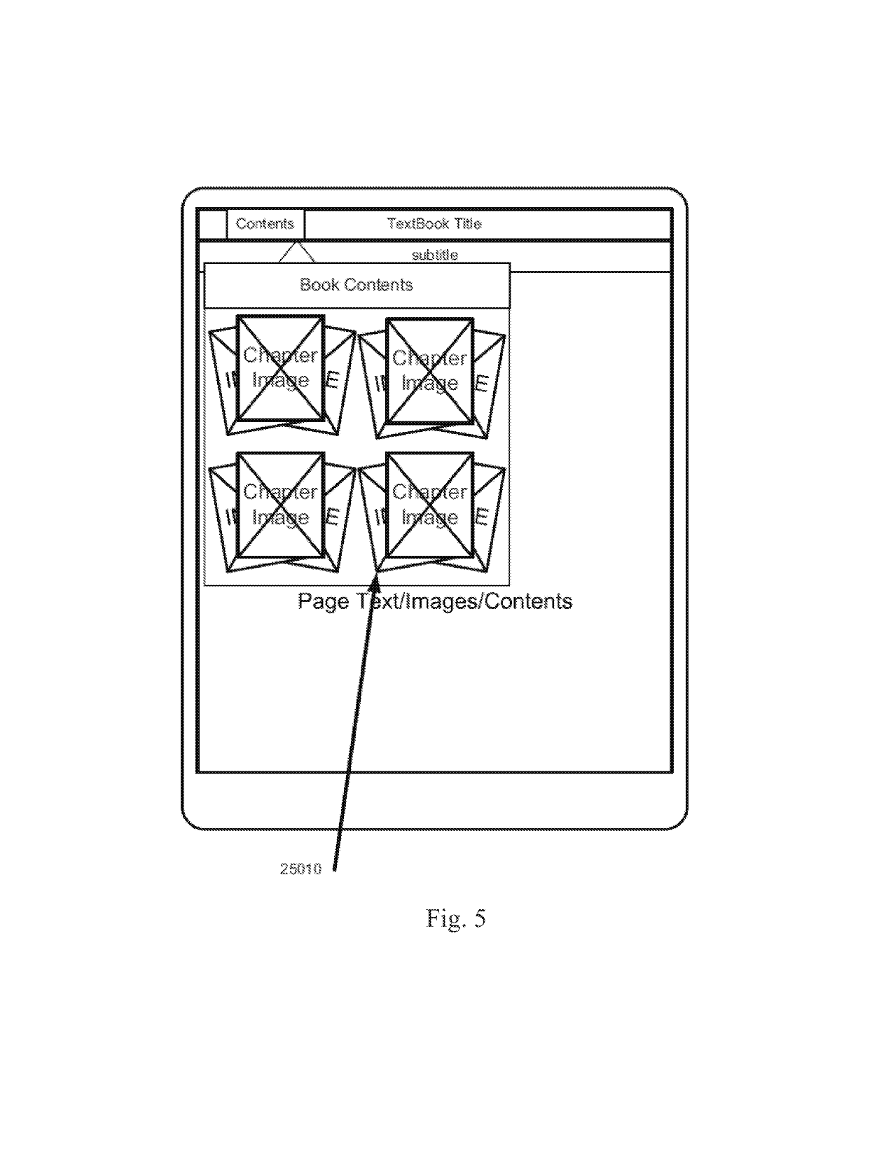

In some examples, the execution environment provides the user with a way to organize already purchased media according to courses, topics, or the like. For example, FIG. 4 shows some examples of an execution environment. Section 22010 identifies 3-dimensional thumbnails of the various “stacks” of cards making up material for various courses in which the user is enrolled. Reference numeral 22020 identifies the various books in the user's digital library the books the user owns or has access to). The material for the various courses may include the user's current assignments for a particular period. Thus if the user is to read chapter 20 in the electronic book and do certain supplemental problems, the cards for chapter 20 and the supplemental problems may appear on the “stack” in section 22010. Reference numeral 22030 illustrates other user navigation aids to access bookstore, settings, and various social features. When a course or textbook is selected, various animations may provide feedback to the user on the selection. For example, if one of the various stacks of cards is selected from the course materials section 22010, the stack may graphically “expand” and allow a user to scroll through thumbnail images of the various media in the stack. Thus for example, if the stack includes a portion of an electronic book as well as other supplements, the user may select which media content to view.

Within an electronic book, the execution environment presents the user with various navigation aids. In some examples, the electronic book allows users to view thumbnail images from various sections of the electronic book. In other examples, the execution environment allows the user to view the titles from various sections of the book. In other examples, the electronic book presents a “virtual spine,” which allows a user to see their relative location in the electronic book. In other examples, the electronic book may provide a navigation aid to show a user his or her assignments for the course in a drop down box. This allows a user to quickly jump to other assignment cards in the stack. FIG. 5 shows some examples of thumbnail navigation 25010 of book sections including chapters, sections, and the like.

In some examples, the execution environment receives and processes input from the user and changes the content presentation in a predefined manner. In some examples the user input includes touches, gestures, keyboard inputs, mouse inputs, trackball inputs, accelerometer or other motion inputs, speech inputs, and the like. Gestures are short, directional movements made by a finger, hand, stylus or other object to make a short, directional movement over a control or object on the screen. In some example, a user is allowed to take and share with other users notes relating to various portions of the book. In other examples, a user may easily navigate through a series or “stack” of cards by flipping or scrolling through a column view.

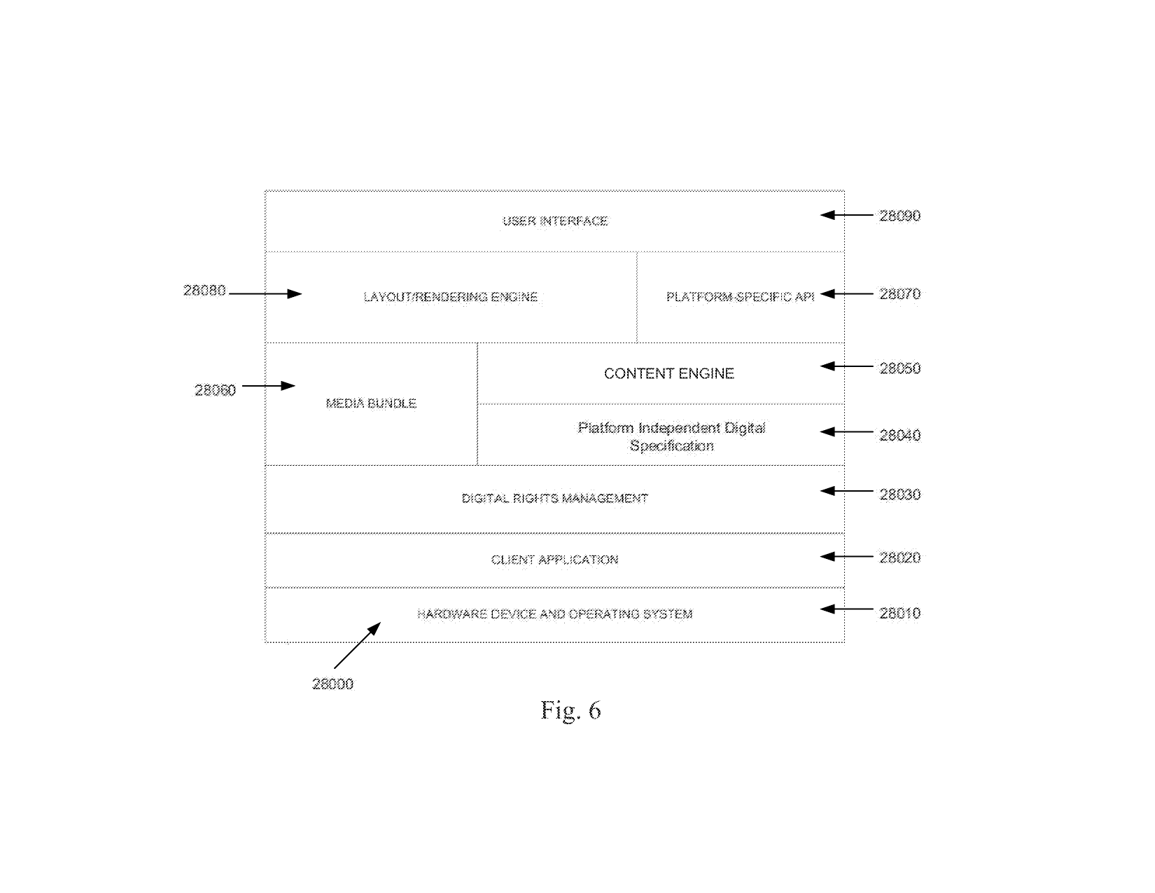

FIG. 6 shows an example system 28000 for an execution environment. In FIG. 6, hardware device and operating system 28010 are shown. Hardware device and operating system 28010 may be dependent on the particular type of electronic reading device. The hardware device and operating system 28010 layers provide the functions for running application software, including the processor, system memory, storage, network interface, TCP/IP stack or other protocol stack, and application programming interfaces for the development of software applications. The hardware device and operating system 28010 may be of any variation including traditional PC-based operating systems, mobile device operating systems or network-based operating systems that abstract the hardware layer from the application programming, interface. Some examples include Microsoft Windows, developed by Microsoft, Corp., Redmond, Wash., UNIX, LINUX, iOS™, MacOS™, Android™, and the like.

Client application 28020 represents the user-level executable the user launches on the client device in order to access the electronic book. In some embodiments, all functions of FIG, 6 may be inside the client application 28020. In other examples, only selected portions are encapsulated in client application 28020.

In some examples, digital rights management process 28030 or “DRM” process authorizes and authenticates a particular user or device in order to allow the user to access appropriate media from the electronic book. The DRM process may authorize an entire book, or selected portions thereof The DRM process also prevents the user and device from accessing electronic books or segments thereof that the user is not authorized to access. In some examples, the DRM process may also be configured to prevent a user or system from extracting text, images, video or other protected assets, and transmitting those assets to another device or writing them out to disk for later retrieval or sharing.

Platform independent digital specification 28040 provides a platform-agnostic representation of all content and metadata for that content. Metadata may include basic information such as the date content was created and/or modified, the version number, and where the content should appear in the context of its bundle. Metadata may also include descriptions of interactive behavior, such as, for example, where audio annotations would be anchored on an image when it is rendered in the system, or how an image might be positioned initially on the screen when a user opens it.

Content engine 28050 is configured to interpret the intermediate platform independent digital specification and read data from the media bundle 28060, providing it in a platform-specific representation to the layout/rendering engine 28080 and the platform specific API 28070. The content engine 28050 may be configured to also handle events such as multi-finger touch inputs to determine the appropriate behavior of the object on screen. Platform specific API 28070 is configured to accept data from the content engine 28050 and media bundle 28060 and determine the appropriate objects to instantiate in order to display the content to the user. The layout/rendering engine 28080 works in parallel with the platform specific API 28070 to render that content to the display. The user interface 28090 is a collection of canonical visual elements that provide the user with known results to input behaviors. For example, the user interface 28090 may be configured to render a small “sticky note” that shows that a given location in a document has an annotation attached.

The execution environment runs on an electronic reader. In some examples, the electronic reader may be an iPad manufactured by Apple, Inc, of Cupertino, Calif., or another tablet computer or electronic reader such as a Nook, manufactured by Barnes and Noble, Inc, of New York, N.Y. or Kindle, manufactured by Amazon.com of Seattle, Wash. In some other examples, the electronic reader may be a laptop, tablet, or desktop computer. In other examples, the electronic reader may be a cellphone or smartphont such as the Apple iPhone™ manuactured by Apple Inc., of Cupertino, Calif. The electronic reader may be any device with a display, an input mechanism, a processor, and electronic storage.

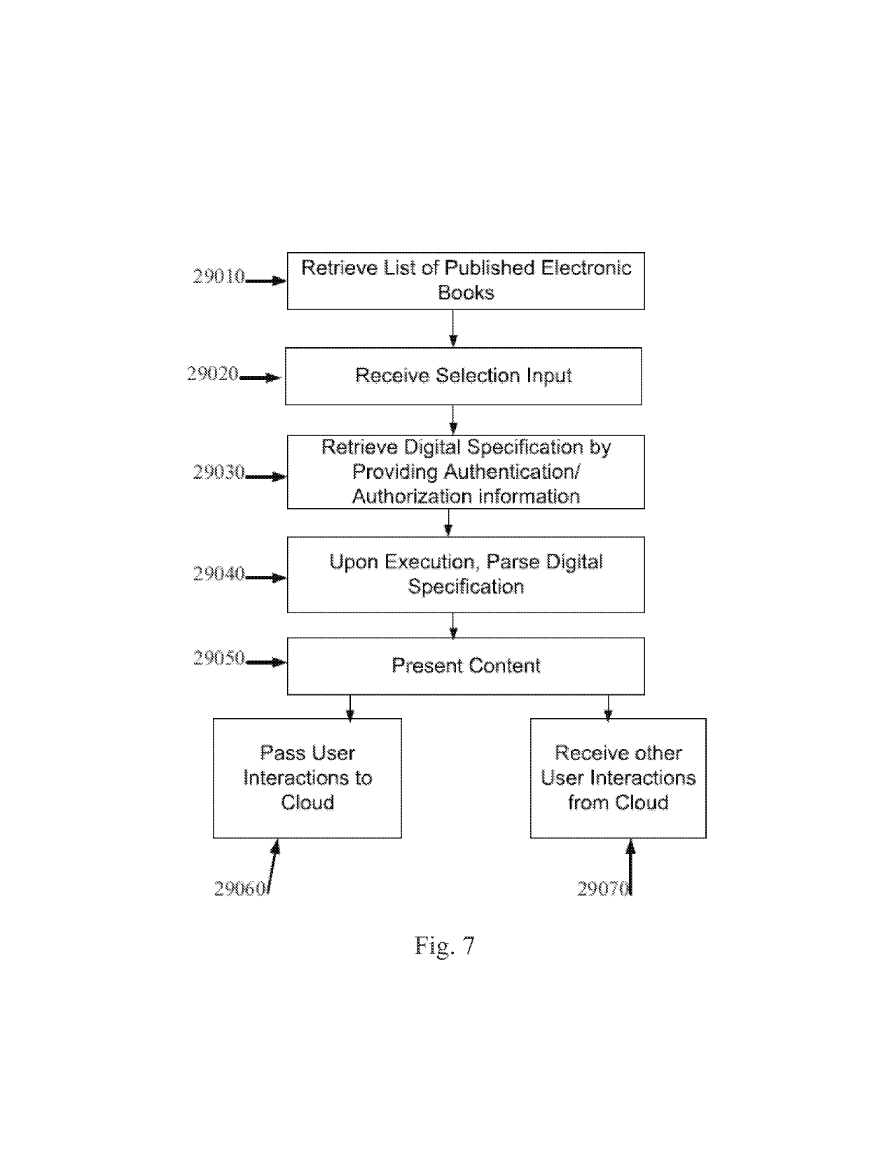

FIG. 7 shows an example method of execution of an electronic reader. In operation 29010, the electronic reader retrieves a list or web page with a list of published electronic books and presents that list or web page to a user. In response to a selection input in operation 29020, the reader retrieves the electronic book by authentication. When the user executes the electronic book in operation 29030, the platform independent digital specification is parsed in operation 29040 and the contents presented in operation 29050. Any user interactions that are social in nature are passed to the content service in operation 29060, and the reader presents to the user any interactions passed from the content service in operation 29070. As used herein, the term “published,” or “publication,” simply refers to the availability of a particular electronic book to users of electronic reading devices.

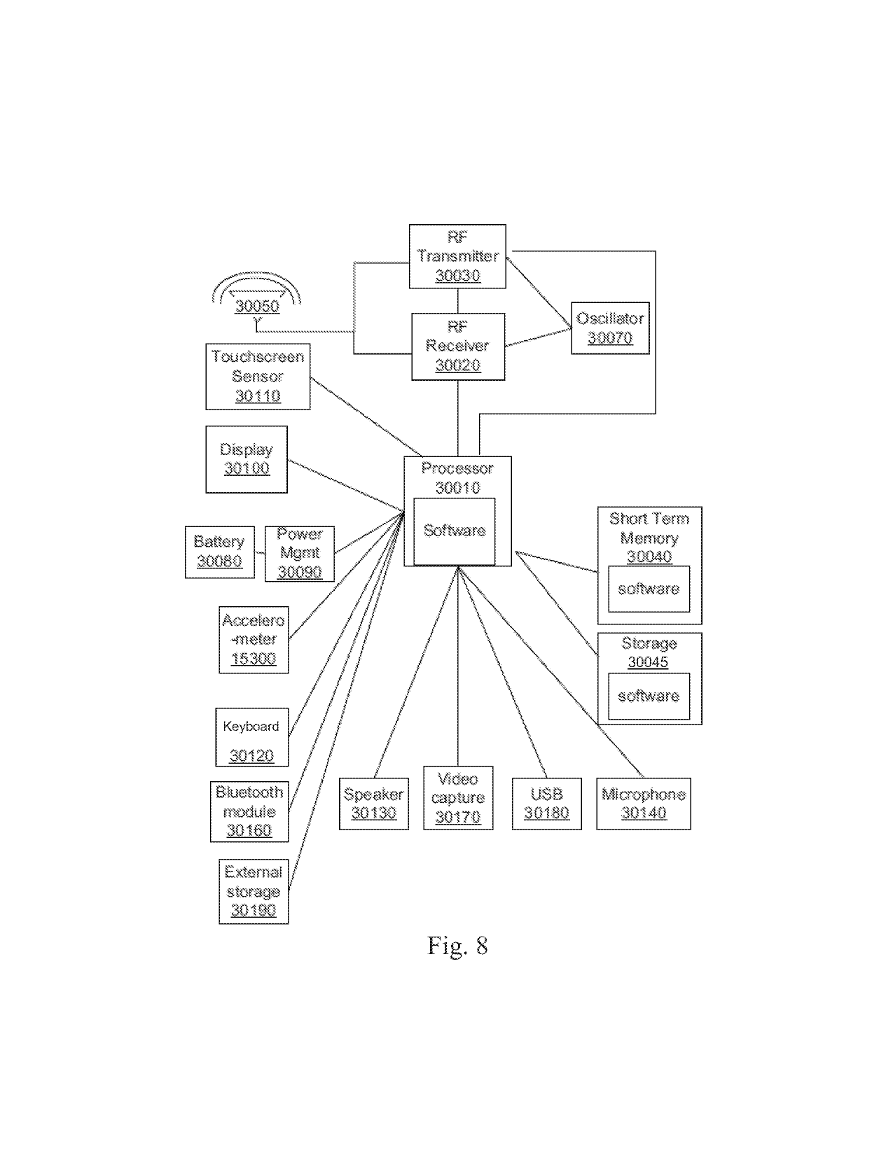

FIG. 8 shows some examples of such a device in the form of a tablet computer. Processor 30010 controls the overall functions of the tablet such as running applications and controlling peripherals. Processor 30010 may be any type of processor including RISC, CISC, VLIW, MISC, OISC, and the like. Processor 30010 may include a digital signal processor (DSP). Processor 30010 may communicate with RF receiver 30020 and RF transmitter 30030 to transmit and receive wireless signals such as cellular, Bluetooth, and Wi-Fi signals. Processor 30010 may use short term memory 30040 to store operating instructions and help in the execution of the operating instructions such as the temporary storage of calculations and the like. Processor 30010 may also use non-transitory storage 30045 to read instructions, files, and other data that requires long term, non-volatile storage.

RF receiver 30020 and RF transmitter 30030 may send signals to the antenna 30050 of display 30100. RF transmitter 30030 contains all the necessary functionality for transmitting radio frequency signals via antenna 30050 given a baseband signal sent from processor 30010. RF transmitter 30030 may contain an amplifier to amplify signals before supplying the signal to integrated antenna 30050. RF transmitter 30030 and RF receiver 30020 are capable of transmitting and receiving radio frequency signals of any frequency, including microwave frequency bands (0.3 to 300 GHz) which include cellular telecommunications, WLAN and WWAN frequencies. Oscillator 30070 may provide a frequency pulse to both RF receiver 30020 and RF transmitter 30030.

Device 30000 may include a battery or other power source 30080 with associated power management process or module 30090. Power management module 30090 distributes power from the battery 30080 to the other various components. Power management module 30090 may also convert the power from battery 30080 to match the needs of the various components. Power may also be derived from alternating or direct current supplied from a power network.

Processor 30010 may communicate and control other peripherals, such as LCD display 30100 with associated touchscreen sensor 30110. Processor 30010 causes images to be displayed on LCD display 30100 and receives input from the touchscreen sensor 30110 when a user presses on the touchscreen display. In some examples touchscreen sensor 30110 may be a multi-touch sensor capable of distinguishing and processing gestures.

Processor 30010 may receive input from a physical keyboard 30120. Processor 30010 may produce audio output and other alerts which are played on the speaker 30130. Speaker 30130 may also be used to play voices (in the case of a voice phone call) that have been received from RE receiver 30020 and been decoded by processor 30010. Microphone 30140 is used to transmit a voice for a voice call conversation to processor 30010 for subsequent encoding and transmission using RE transmitter 30030. Microphone 30140 may also be used as an input device for commands using voice processing software. Accelerometer 15300 provides input on the motion of the device 30000 to processor 30010. Accelerometer 15300 may be used in motion-sensitive applications. Bluetooth module 30160 may be used to communicate with Bluetooth-enabled external devices, Video capture device 30170 may be a still or moving picture image capture device or both. Video Capture device 30170 is controlled by processor 30010 and may take and store photos, videos, and may be used in conjunction with microphone 30140 to capture audio along with video. USB port 30180 enables external connections to other devices supporting the USB standard and charging capabilities. USE port 30180 may include all the functionality to connect to, and establish a connection with, an external device over USE. External storage module 30190 may include any form of removable physical storage media such as a flash drive, micro SD card, SD card, Memory Stick and the like. External storage module 30190 may include all the functionality needed to interface with these media.

### The Infrastructure

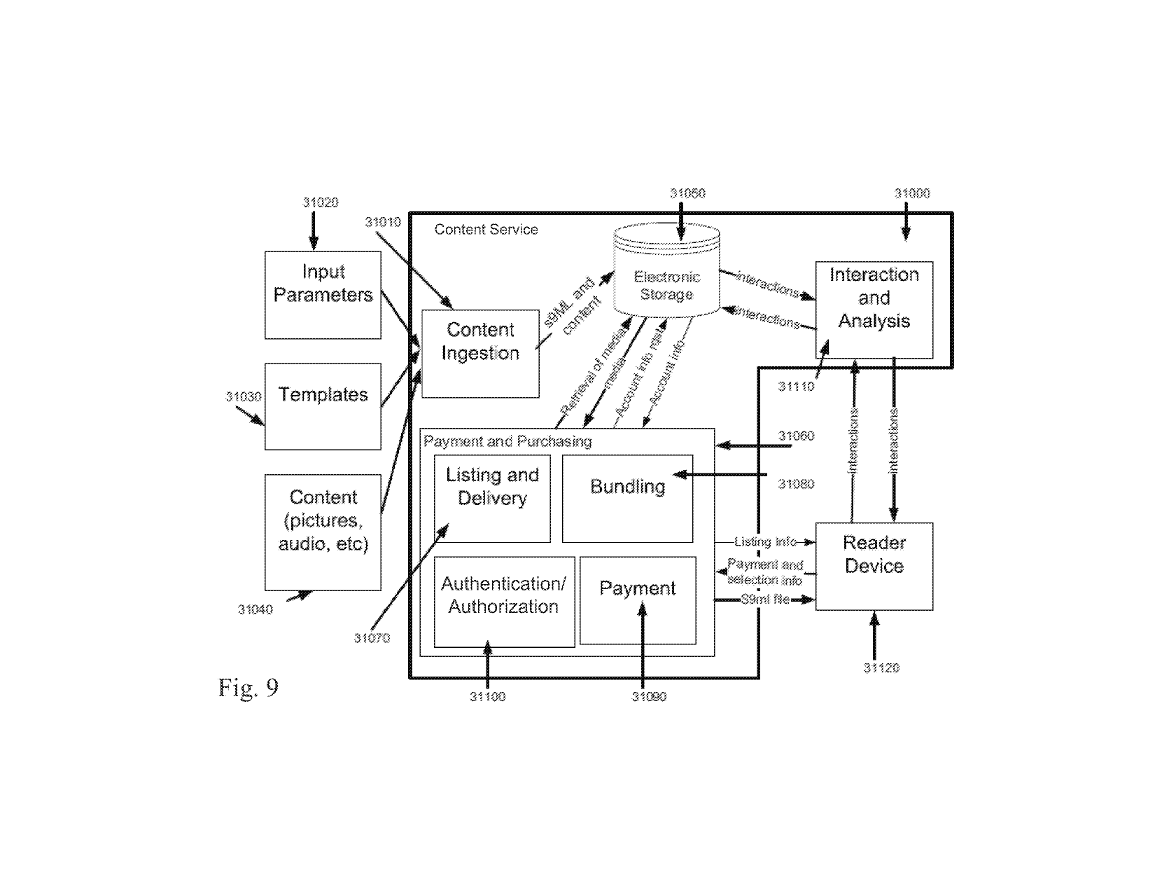

Content service 1010 (see FIG. 1), in some examples, includes data storage, authentication and authorization services, social networking services, content ingestion, listing and publishing services and bundling services. One example interactive content service 31000 is shown in FIG. 9.

In FIG. 9, content ingestion module 31010 takes input parameters 31020, templates 31030, and content 31040 and creates a platform-independent digital specification of an electronic book. The input parameters 31020, templates 31030, and content 31040 may be provided by content creators. The platform-independent digital specification may be in any format which an execution environment of an electronic reader may read, interpret, and process in order to display the content presentation items of the electronic book. The platform-independent digital specification may also include parameters for any various interactive content presentation objects that tell the execution environment how to handle user interaction. In some examples, the platform-independent digital representation may be one or more s9ML files, which in some examples may be an XML, HTML, or other markup language file according to a defined structure.

The content ingestion module 31010 may store the generated platform-independent digital specification in electronic storage 31050. Electronic storage 31050 may be any electronic storage capable of storing and retrieving the digital specifications and the media. In some examples electronic storage 31050 is a separate system such as a network attached storage (NAS) or storage area network (SAN) system.

Payment and purchasing module 31060 may be capable of handling advertising of the availability of a particular electronic book stored in electronic storage to a plurality of reader devices 31120. :In some examples, payment and purchasing module 31060 may communicate the availability of titles directly to the electronic readers either by pushing the availability information to the execution environment of the readers (which may have a marketplace application executing) or by allowing the reader to request the information through, for example, a web interface. Thus, in some examples, the payment and purchasing module 31060 may function as a web server, and in other examples it may function as a data source for a store application on the reader device 31120 itself. In still other examples, payment and purchasing module 31060 may communicate title availability to a third-party web merchant site, such as Amazon, iTunes or the iPhone App Store.

Payment module 31090 may payments from reader devices 31120. In some examples, this may include credit card processing functions. In other examples, this includes electronic payment interfaces to third-party applications such as that of PayPal, run by eBay, Inc. of San Jose, Calif., In some examples, payment module 31090 may maintain a credit or debit account for the user of a reader device 31120.

Authentication and authorization module 31100 may be capable of authenticating a reader device 31120 and authorizing the reader device 31120 to view the requested content. In some examples, the electronic book may contain digital rights management software. The authentication and authorization module 31100 may work with the digital rights management of the electronic book or the digital rights management of the electronic reader to authorize the user to access the content. In some examples, the authentication and authorization module 31100 works with the payment module 31090 to authenticate and authorize the content only after payment is verified or received.

Once the content is paid for, authenticated, and authorized, listing and delivery module 31070 delivers, or makes available for delivery, the electronic book or a portion thereof. In some examples, the reader device 31120 downloads the platform-independent specification. In other examples, the platform-independent specification is streamed as the user is viewing the content. In yet other examples, the listing and delivery module 31070 informs a third-party content storage facility to deliver, or authorize the delivery of, the content.

In some examples, the electronic book may be tagged by the chapter, sentence, paragraph, word, or any arbitrary segment. In some examples, users may purchase only certain portions of the electronic book based on this tagging. Dynamic sequencing is discussed in detail in U.S. patent application Ser. No. 12/911,247 entitled “Methods for sequencing electronic media content,” to Peter Cho (Attorney Docket Number 3337.002US1), which is hereby incorporated by reference herein in its entirety. In other examples, these tags are used to share social content interactions. Bundling application 31080 uses these tags, along with information on which portions of the electronic book to send to the reader device 31120, to bundle all the proper content together so it can be sent to the reader device 31120, rather than sending the entire electronic book.

Interaction and analysis module 31110 receives, processes, stores and sends to other reader devices 31120 interactions from users. These interactions may include, in some examples, user comments relating to a portion of the electronic book, user questions, or any other interactions. Some examples, the interactions may be text; in other examples it may be any combination of text, graphics, photos, HTML links, or the like. Interactions may also include, in some examples, interactive bookmarks to share a particular user's location in the content with other content users. Other interactions may include highlighting, which shares a particular user's highlighting choices with other users. Interaction and analysis module 31110 also receives assessment results from the electronic readers 31120. Interaction and analysis module 31110 may then provide various reports about the test performance of a particular user and about all users who submitted results. These reports may include reports on how well an assessment is designed and may be intended for the content designer. For example, if most individuals performed extremely well, it signals that the assessment may have been too easy. Other reports include reports sent to users who have completed assessments showing their results, as well as showing results of other users who have completed the assessments. These reports may be made anonymous so that users may not directly see other users' scores. In some examples, only an average score will be shown. In other examples a ranking may be shown to indicate where a particular user is with respect to other users.

It will be appreciated that the components inside the content service 31000 could be implemented as separate components, or those components not shown as part of content service 31000 could be included as part of content service 31000. Additionally, the various components could be executing on the same hardware, or on different hardware connected through a computer network. In some examples, this computer network may include LAN, WAN, the Internet, Wi-Fi, Wi-Max, cellular, and any other method of data transmission. In some other examples, different hardware components may be connected through local connections such as fiber, Ethernet, serial, parallel, PS2, USB, wireless, infrared, FireWire or the like. Electronic reader devices 31120 may communicate with the content service 31000 through direct connections such as USB, Ethernet, serial, parallel, PS2, USB, wireless, infrared, FireWire, or the like. In other examples, electronic reader devices 31120 may communicate with the content service 31000 through a computer network. In some examples, the reader devices 31120 access the computer network through wired connections such as USE, Ethernet, FireWire, or the like, but in other examples, the reader devices 31120 may access the computer network through wireless means such as Wi-Fi, Bluetooth™, satellite, cellular data communications including but not limited to analog, digital, 2nd Generation (2G) systems such as integrated Digital Enhanced Network (iDEN), Global System for Mobile Communications (GSM), 2.5G systems such as General Packet Radio Service (GPRS), 2.75G systems such as Enhanced Data Rates for GSM Evolution (EDGE), 3G systems such as Universal Mobile Telecommunications System (UMTS), and 4G Systems such as the Worldwide Interoperability for Microwave Access (WiMAX), and Long Term Evolution (LTE) systems, and the like.

While the digital specification is sent unchanged, in some examples, to the reader devices 31120, in other examples, minor modifications are made depending on the device type. This is because there may be little benefit in sending bigh-resolution image to a reader device 31120 that is a cellphone which is incapable of rendering such a high-resolution image. Thus, to better put the electronic book in a form ready for presentation, the content service 31000 may modify the content according to the target reader device 31120.

### 3D Modeling

As discussed above, content may include a 3D model that may rotate based on a user input or gesture (e.g., dragging and rotating the model using a mouse or a user's finger on a touch screen). A 3D model may be created by a content creator using any 3D modeling tool or graphics API. One example of a graphics API is OpenGL, which is a standard specification for an API for writing applications that produce 3D computer graphics or models. Other examples of graphics APIs include X3D, Direct3D, RenderMan, etc. When a 3D model is created, a mathematical representation of a 3D surface is generated using the 3D modeling tool. The source material for the model may come from the 3D modeling tool itself or may be scanned from a real-world object and transformed to the mathematical representation. A 3D model may be formed from primitives such as points, tines, polygons, vertices, etc. which define the shapes and surfaces of the model. Examples of 3D modeling representation may include polygonal modeling, curve modeling, digital sculpting, etc.

Once a 3D model is created, the layout for the 3D model may be created. For example, the 3D model may be placed or laid out within a particular scene. Additionally, any animation may be added to the 3D model. The animation may define how an object moves and deforms over time.

The 3D model may also be rendered using the graphics API. 3D rendering occurs when a 3D model is converted into an image using a graphics API so that the image can be displayed on a 2D display. Although the image is 2D, it may have the appearance of a 3D object by adding any 3D style (e.g., light transport, reflection, shading, etc.).

A 3D model may be generated and rendered on a display using data such as the points, lines, polygons, vertices, etc. that define the shapes and surfaces of the model. In some embodiments, a vertex buffer may contain and maintain this data for the perspective currently being viewed by the user. For example, if the user were viewing the anterior perspective of a 3D model, the vertex buffer may contain the vertex data for that particular anterior perspective.

As discussed above, the 3D model may be moved, scaled, or rotated based on a user input. In some embodiments in which the display is a touch screen, the 3D model may be scaled by pinching or unpinching the displayed model. When the 3D model is moved to view from one perspective to another particular perspective, the vertex buffer may be updated accordingly to reflect the data for that particular perspective. The 3D model may exhibit any type of rotation mode for deciding how to respond to a user input or gesture indicating a rotation or pan of the 3D model. The type of rotation mode used may be defined by the 3D model. In some embodiments, a free rotation mode may be used. The free rotation mode rotates a 3D model in response to a user input using a technique known as an arcball rotation model. Instead of rotating the 3D model about a fixed point at the origin of the model, the arcball rotation rotates the 3D model as if the center of the virtual ball is directly underneath wherever the user began the gesture. In some embodiments, an axis rotation mode may be used. An axis rotation allows the model to rotate in a manner similar to the free rotation mode, but under the additional constraint that an entire axis is fixed. In axis rotation mode the rotation of the model resulting from a given user gesture may be calculated as follows. The rotation that occurs based on the user's input in arcball mode may be computed. This rotation may be represented by an axis of rotation, A, and number of degrees, D, by which the model is to be rotated about A, The actual rotation of the model in axis rotation mode may then be determined as “D’ degrees about the fixed axis,” where D′ is equal to D times the dot product of A and the fixed axis. In some embodiments, a plane rotation mode may be used. A plane rotation allows the user to rotate the 3D model between +90 degrees and −90 degrees about the x-axis, and may allow the user to rotate the model freely about the axis that is the result of rotating the standard y-axis by the x-axis rotation. For example, when there is zero rotation about the x-axis, the user may rotate the model freely about the standard y-axis. When there is a rotation of 90 degrees about the x-axis, the user may rotate the model freely about the standard z-axis (that being the result of rotating the standard y-axis 90 degrees about the x-axis). In some embodiments, the rotation information may be represented as a quaternion, the information content of which is an axis of rotation and an angle specifying the amount of rotation about that axis.

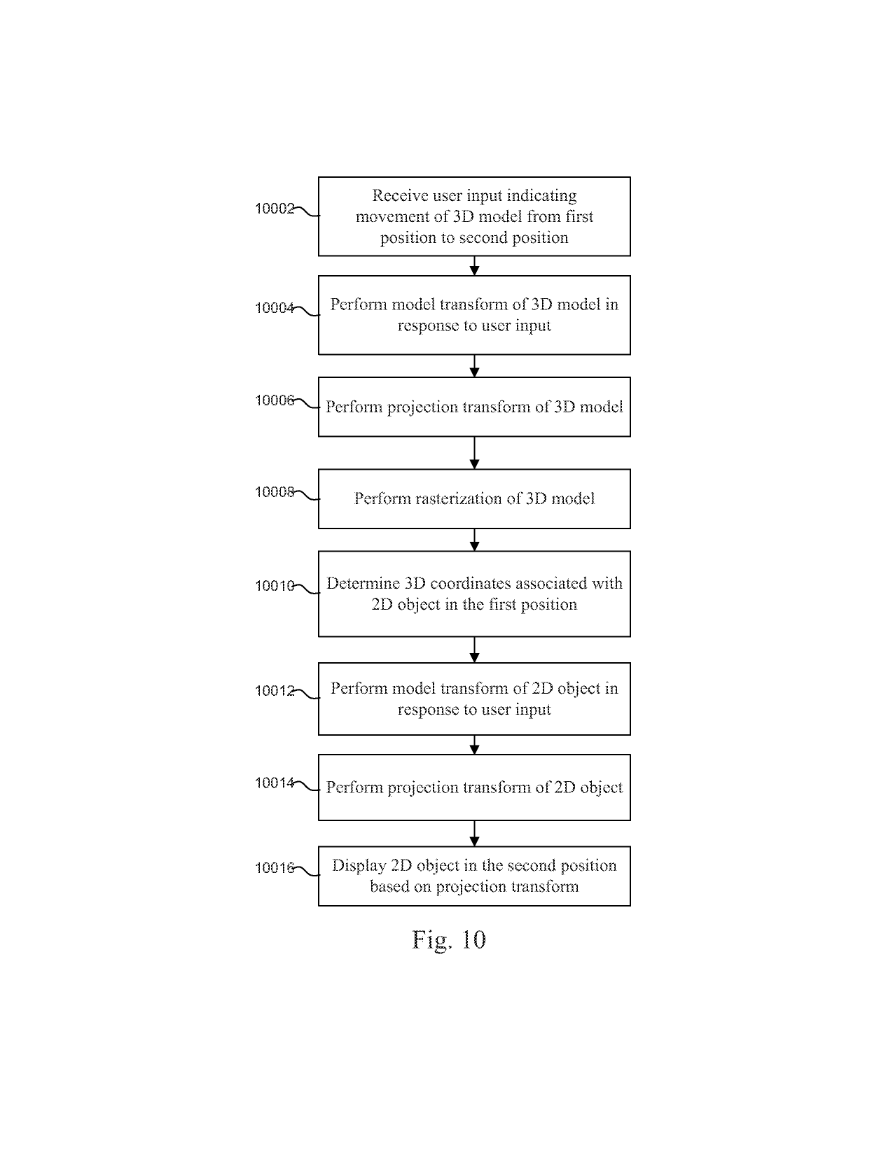

The 3D model may be associated with one or more 2D annotation objects which may contain additional information about different points or locations on the 3D model. These 2D objects may appear anchored to the 3D model at these different points or location on the 3D model and may maintain behaviors that are native to the operating system of the user device. FIG. 10 is a flow chart showing an example method of rendering the 3D model associated with the 2D object. The 3D model and the associated 2D object may be content delivered by the listing and delivery module 31070 (FIG. 9) and may either be downloaded onto the user device or may be streamed as the user is viewing the content.

When a user is viewing a 3D model, the user may move and change perspective of the 3D model. The 3D model and any associated 2D annotation objects may move such that the 2D annotation objects appear anchored to particular locations on the 3D model as the 3D model is being moved. In operation 10002, a user input indicating movement of the 3D model being displayed to the user may be received. The user input may indicate movement from a first position or perspective (e.g., the perspective being viewed by the user prior to the user input) to a second position or perspective of the 3D model. The user input may indicate any movement of the 3D model (e.g., rotation, scale, etc.). For example, the user input may indicate a movement from the anterior position of the 3D model being viewed to the posterior position of the 3D model. A vertex buffer may contain the data associated with the first position being viewed by the user.

In operation 10004, a model transform of the 3D model may be performed in response to the user input using the graphics API for rendering the 3D model. The model transform may change the data in the vertex buffer based on the user input to reflect the second position. For example, a user input indicating a change in the scale of the 3D model may change the data in the vertex buffer according to the appropriate scale. A user's input indicating a rotation may change the data in the vertex buffer according to the appropriate rotation. The model transform may be performed in any manner.

In some embodiments, a transformation of the 3D model may be represented by a matrix. The matrix may be generated based on the user input and the appropriate characteristics associated with movement of the 3D model (e.g., rotation mode, scale characteristics, etc.). For each vertex in the vertex butler of the 3D model in the first position, a vertex for the 3D model in the second position (w) is calculated using the matrix representation of the transformation (M) and the vertex in the first position (v) (e.g., w=Mv). The vertex buffer is updated with the calculated vertex for the 3D model in the second position. Any data associated with how the vertices are connected with one another is preserved in the vertex buffer.

In some embodiments, a user's input indicating a rotation may be represented and manipulated as a quaternion. However, in some cases, a 3D rendering tool may process model transforms via a matrix representation of the movement. In these cases, the quaternion representation may be manipulated and transformed to the corresponding matrix representation so that the 3D rendering tool may process the model transform. For example, when the user applies a particular input or gesture, the appropriate rotation quaternion is calculated based on the user input and the active rotation mode of the 3D model. The calculated quaternion is converted to the matrix form of the 3D rendering tool being used, and the vertex buffer may be updated accordingly to reflect the rotation.

In operation 10006, a projection transform is performed for the transformed model using the graphics API. The projection transform projects the transformed model into a unit cube. Any type of projection transform may be used. In some embodiments, a perspective projection transform may be used, which may simulate a vanishing point at the center of the screen. In some embodiments, an orthographic projection transform may be used, which may project the model transform to a unit cube without making distant points converge toward any vanishing point. Under an orthographic projection transform, distant objects do not appear smaller than closer objects, which may be useful for 3D models of smaller objects, where the user may not necessarily perceive a vanishing point when viewing the object in the real world.

The transformation that projects the transformed model to the unit cube may also be represented as a matrix. In some embodiments, instead of manipulating the model transform by the matrix representing the movement based on the user input, the projection transform may be performed by projecting the 3D model in the first position into a unit cube and manipulating that projection transform by the matrix representation. In some embodiments, the model transform operation and the projection transform operation may be performed in any logical manner to arrive at the transformed model projected into a unit cube. For example, the model transform and the projection transform may be used to arrive at a resulting matrix representation, and that matrix representation may be applied to each vertex of the 3D model in the first position to obtain an updated vertex buffer for the 3D model in the second position.

In operation 10008, rasterization of the projected transform is performed using the graphics API. The rasterization operation renders the projected transform to a 2D surface (e.g., pixels on a display screen) for output on a display via the graphics API. The rasterized model is rendered on a 2D screen yet maintains the appearance of a 3D model.

Once the 3D model_{—} is rendered based on the user input, any 2D objects associated with the 3D model may also be moved based on the user input. In operation 10010, 3D coordinates associated with a 2D object in the first position may be determined. The 3D coordinates associated with the point on the 3D model to which the 2D object should appear anchored is maintained and used when a user input is received.

The determined set of 3D coordinates for the 2D object in the first position may then be transformed to a set of 3D coordinates for the 2D object in the second position using the graphics API, In operation 10012, a model transform similar to the model transform of operation 10004 is performed for the 2D object using the determined 3D coordinates for the 2D object via the graphics API. For example, the 3D coordinates for the particular location on which the 2D object is anchored may be updated by the matrix representing the movement based on the user input, in operation 10014, a projection transform similar to the projection transform of operation 10006 is performed for the 2D object using the model transform of the 2D object via the graphics API.

In operation 10016, instead of using the graphics API to rasterize the 2D object for display, controls native to the operating system of the user device are used to display the 2D object in the second position. The 2D coordinates may be calculated using the 3D coordinates of the projection transform of the 2D object and may be calculated based on the size of the display. The 2D object displayed at the calculated 2D coordinate location is a native control displayed at the particular location on the 3D model to which the 2D object may appear anchored. The 2D object may have the functionality of a native control yet appear to move and be anchored to the 3D model at that particular location.

If a user subsequently moves the 3D model, the operations of FIG. 10 may be performed again. The 3D coordinates of the 2D object are maintained with each transformation (e.g., user input) so that the 2D object may appear to move fluidly with the 3D model. Additionally, the operations of FIG. 10 may be performed several times as the user moves the 3D object so that the 3D model and the 2D object appear to move with the user's inputted movement.

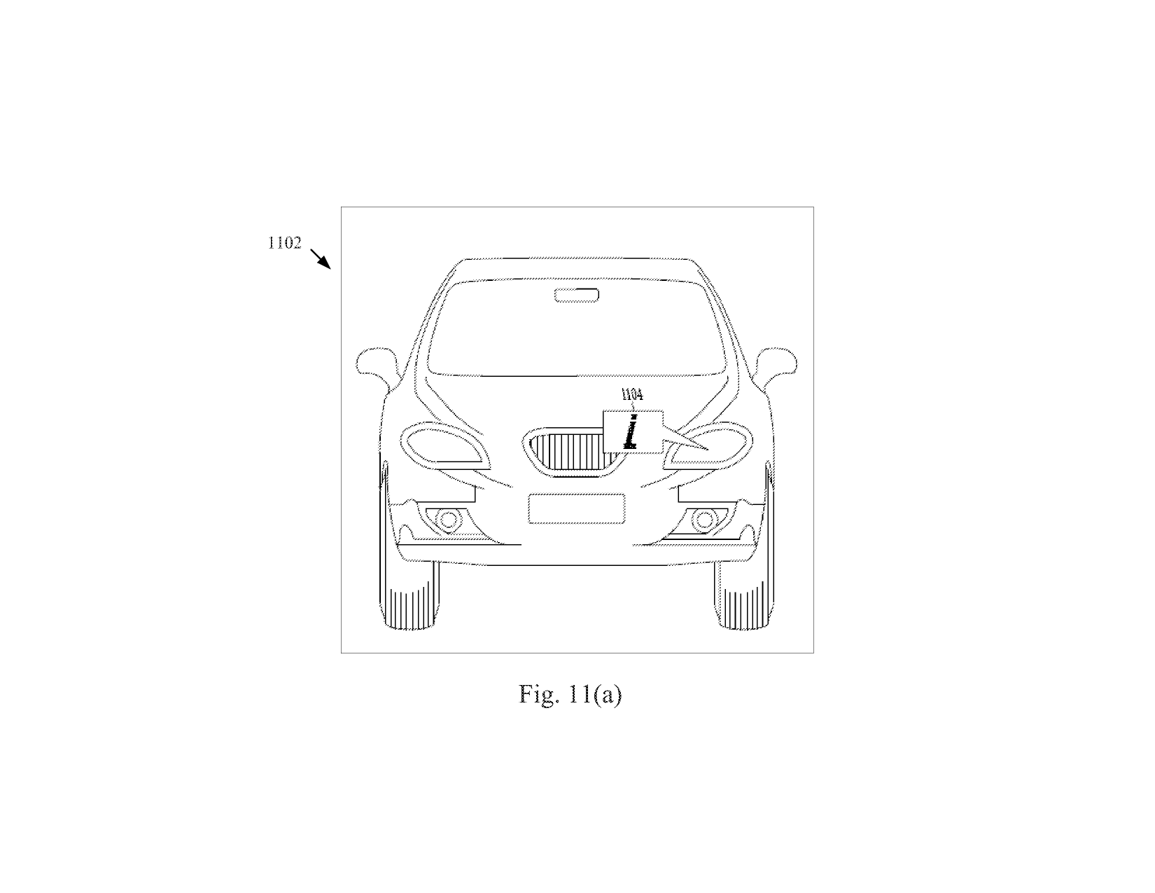

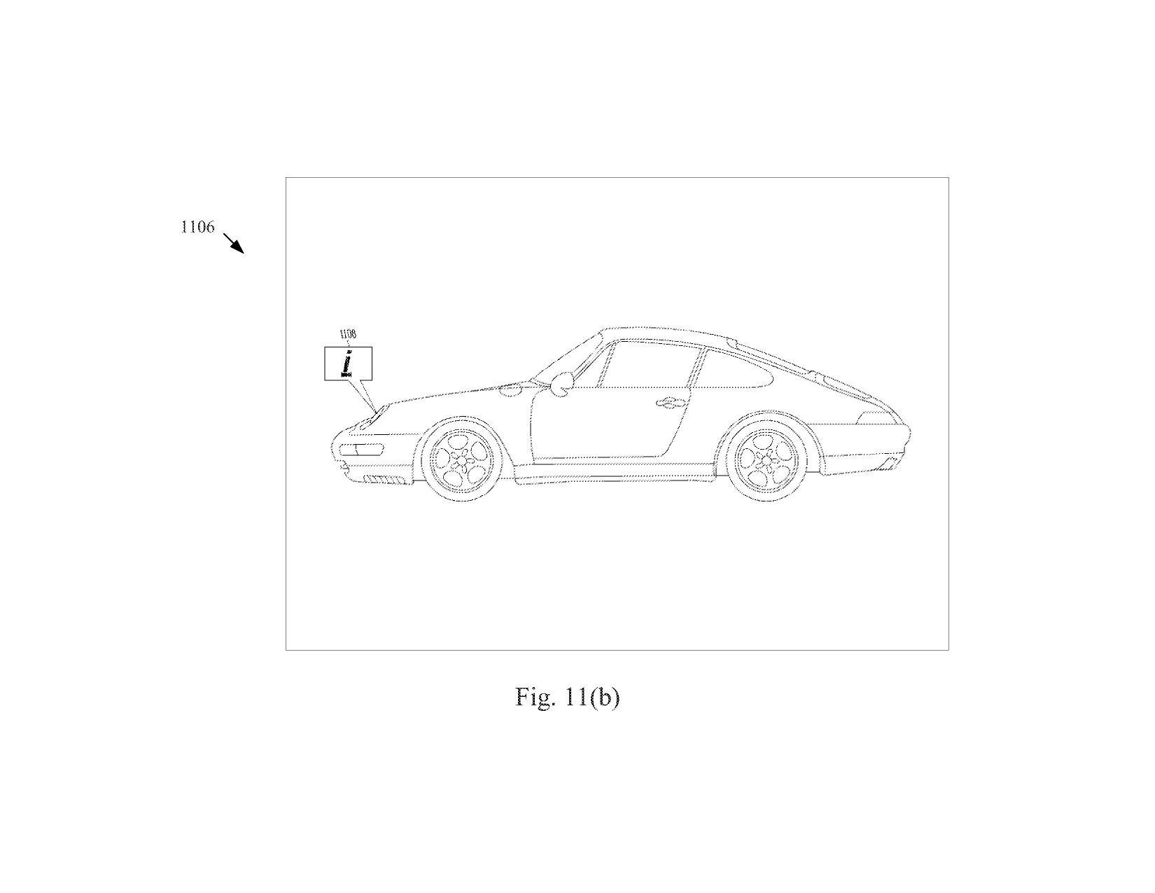

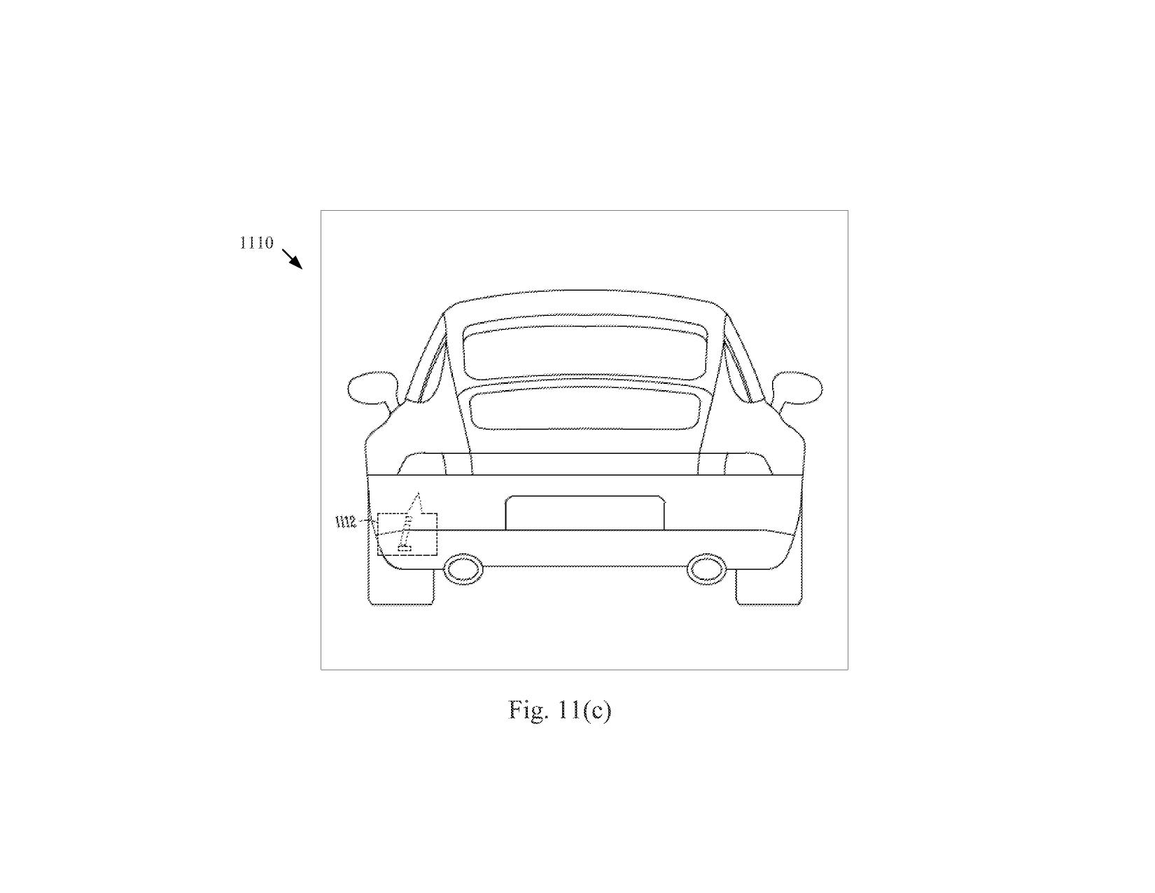

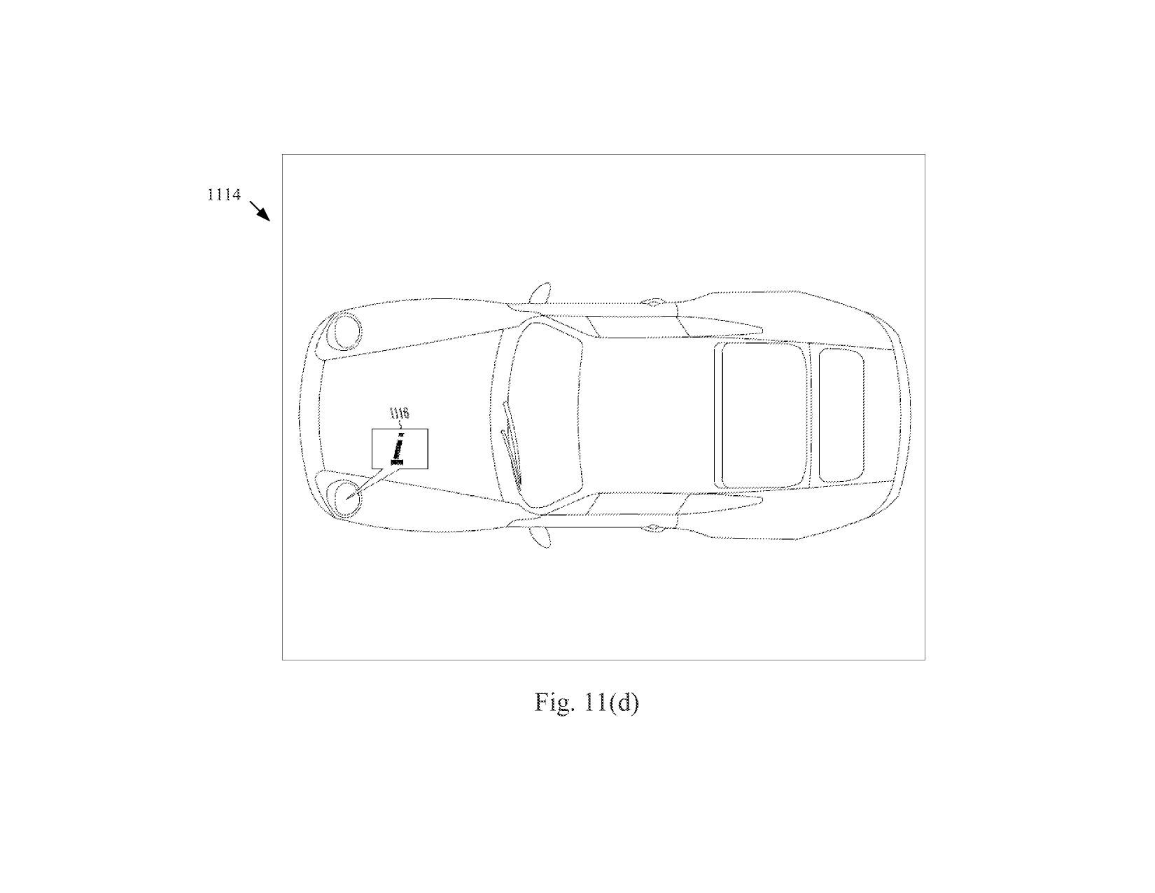

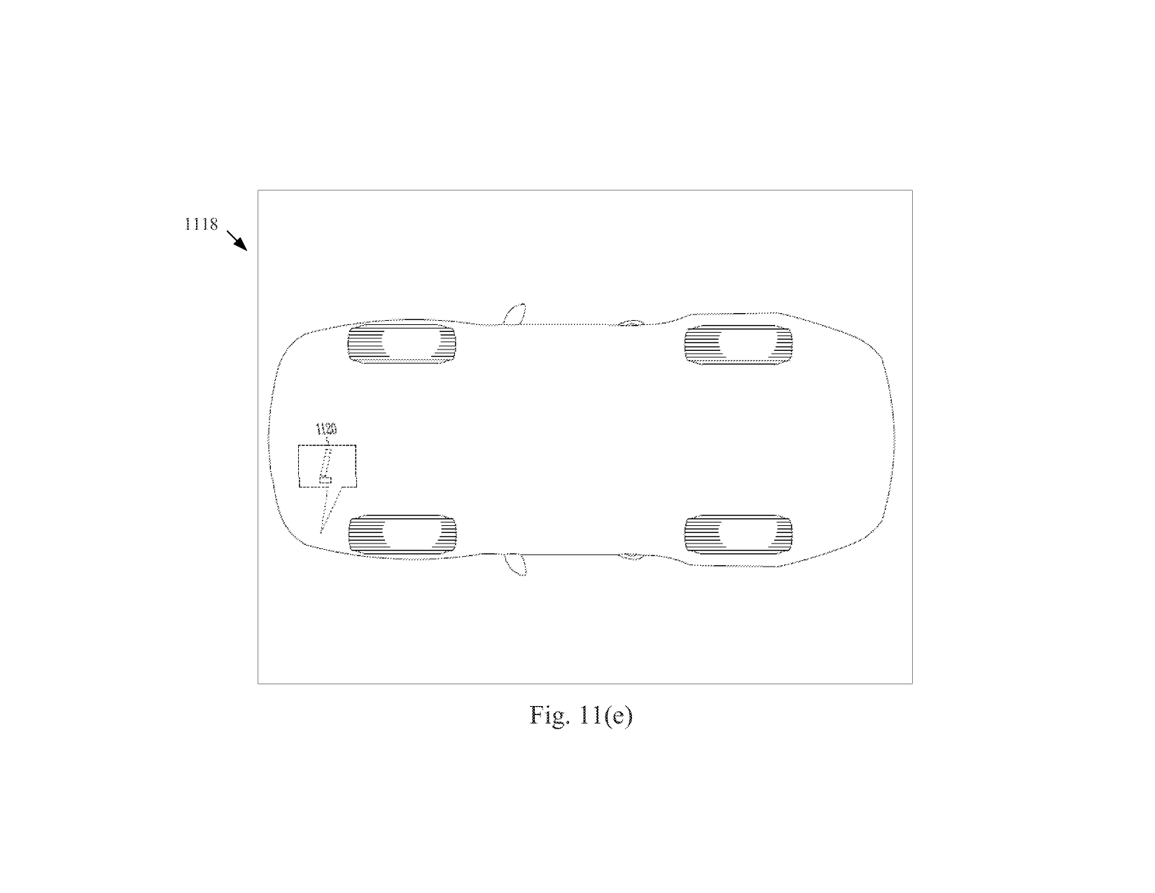

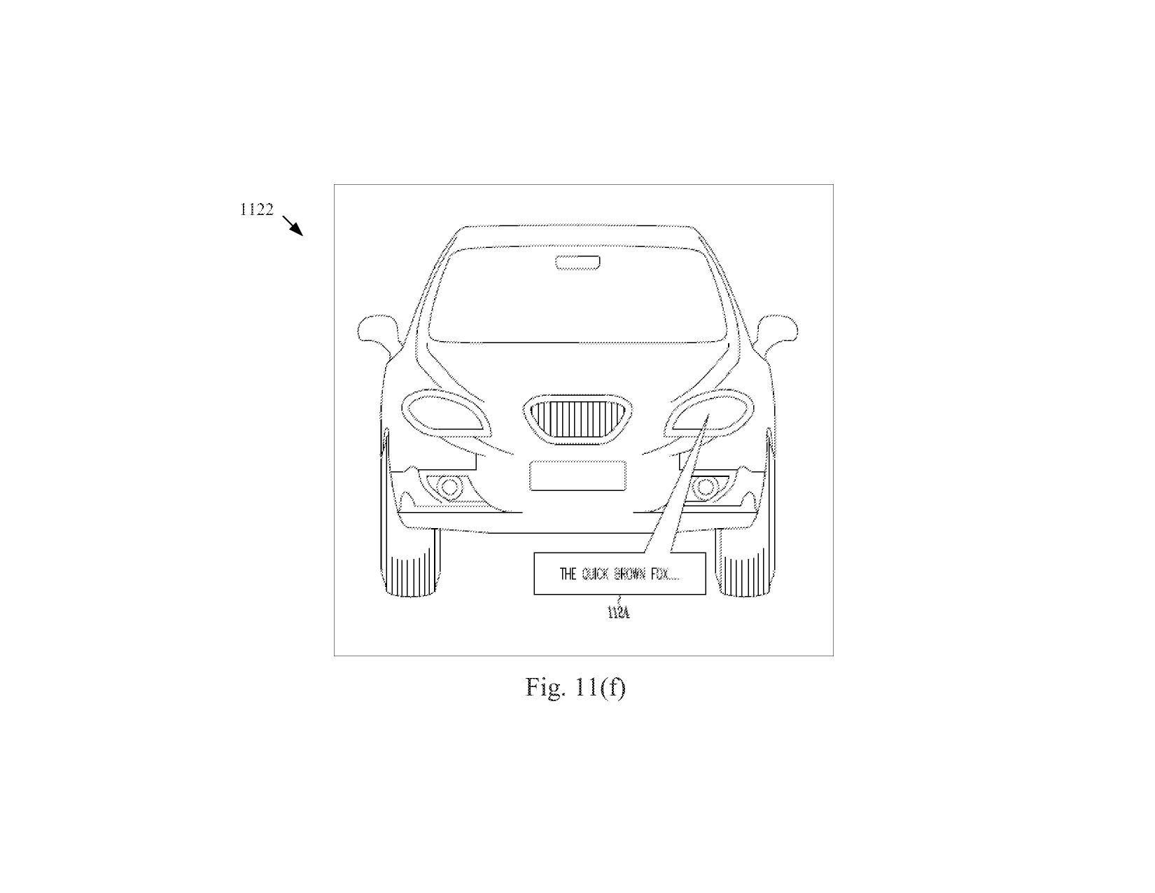

FIGS. 11(a)-(1) show example views of a 3D model associated with a 2D object. In FIG. 11(a), an exemplary 3D model, is depicted as a vehicle 1102 rendered on a display. A 2D annotation object 1104 appears anchored to a headlight. The 2D annotation object 1104 is depicted as an icon. In some embodiments, the 2D object may be expandable to show additional information associated with the location to which the 2D object points. For example, the 2D object may contain additional information associated with the headlight to which it points.

FIG. 11(b) depicts the 3D model of a vehicle 1106 after a user rotates the 3D model so that the side of the vehicle 1106 is rendered (e.g., after the operations of FIG. 10 are performed in response to the user rotation). The associated 2D object 1108 is also displayed as anchored to the headlight of the vehicle 1106 per the operations of FIG. 10.

FIG. 11(c) depicts the 3D model_{—} of a vehicle 1110 after a user rotates the 3D model so that the rear of the vehicle 1110 is rendered (e.g., after the operations of FIG. 10 are performed in response to the user rotation). The associated 2D object 1112 is also displayed as anchored to the headlight of the vehicle 1110 per the operations of FIG. 10.

In some embodiments, a 2D object may be displayed in a faded manner to indicate that the 2D object points to a location on the 3D model that is not in the foreground of the perspective being displayed, and 2D objects in the foreground may be displayed in a bolder manner. As shown in FIG. 11(c), because the headlight is in the front of the vehicle 1110, the 2D object 1112 anchored to the headlight may be displayed in a faded manner to indicate that the 2D object 1112 is anchored to a location on the vehicle 1110 that is in the background or behind the perspective of the 3D model being displayed. This case, after the projection transform of the 2D object is performed (operation 1014 of FIG. 10), the 3D coordinates of the 2D object may be used to determine whether the 2D object is anchored to a location that is in the background or behind the perspective being displayed. For example, the z-coordinate may be determined for the 2D object. If the z-coordinate is outside a predetermined range (e.g., the z-coordinate is greater than zero), the 2D object may be displayed in operation 1016 in a faded manner.

In some embodiments, the 2D object may be associated with an arrow directionality in order to optimize the display space. After the projection transform of the 2D object is performed (operation 1014 of FIG. 10), the 3D coordinates of the 2D object may be used to determine whether the directionality of the arrow should be changed. The directionality may change in any manner based on any considerations, such as whether a particular coordinate is within or outside a particular range. For example, if the location at which the 2D object is displayed changes from a positive x-coordinate to a negative x-coordinate in response to a user input, the left-right arrow directionality may change to optimize the display space. Similarly, if the location at which the 2D object is displayed changes from a positive y-coordinate to a negative y-coordinate in response to a user input, the up down arrow directionality may change to optimize the display space. Once the arrow directionality is determined, the 2D object may be displayed in operation 1016 in the appropriate direction.

FIG. 11(d) depicts the 3D model of a vehicle 1114 after a user rotates the 3D model so that the top of the vehicle 1114 is rendered (e.g., after the operations of FIG. 10 are performed in response to the user rotation). The associated 2D object 1116 is also displayed as anchored to the headlight of the vehicle 1114 per the operations of FIG. 10,

FIG. 11(e) depicts the 3D model of a vehicle 1118 after a user rotates the 3D model so that the rear of the vehicle 1118 is rendered (e.g., after the operations of FIG. 10 are performed in response to the user rotation). The associated 2D object 1120 is also displayed in a faded manner as anchored to the headlight of the vehicle 1118 per the operations of FIG. 10, which is in the background or behind the perspective being displayed.

FIG. 11(f) depicts the 3D model of a vehicle 1122 when the 2D object 1124 is expanded to display additional information contained in the 2D object 1124. If the 2D object 1124 is expanded, the display of the vehicle 1122 and the 2D object 1124 may be changed to optimize the display space so that the 3D model and the 2D object 1124 can be properly displayed. When the 2D object 1124 is expanded, additional information about the model (and particularly the point on the model to which object 1124 is anchored) may be displayed. The operations of FIG. 10 may be performed based on the user input (e.g., expanding or minimizing the 2D object 1124) and may take into account the additional display information associated with the expansion or minimizing of the 2D object 1124 so that the 3D model and the 2D object 1124 may be properly displayed.

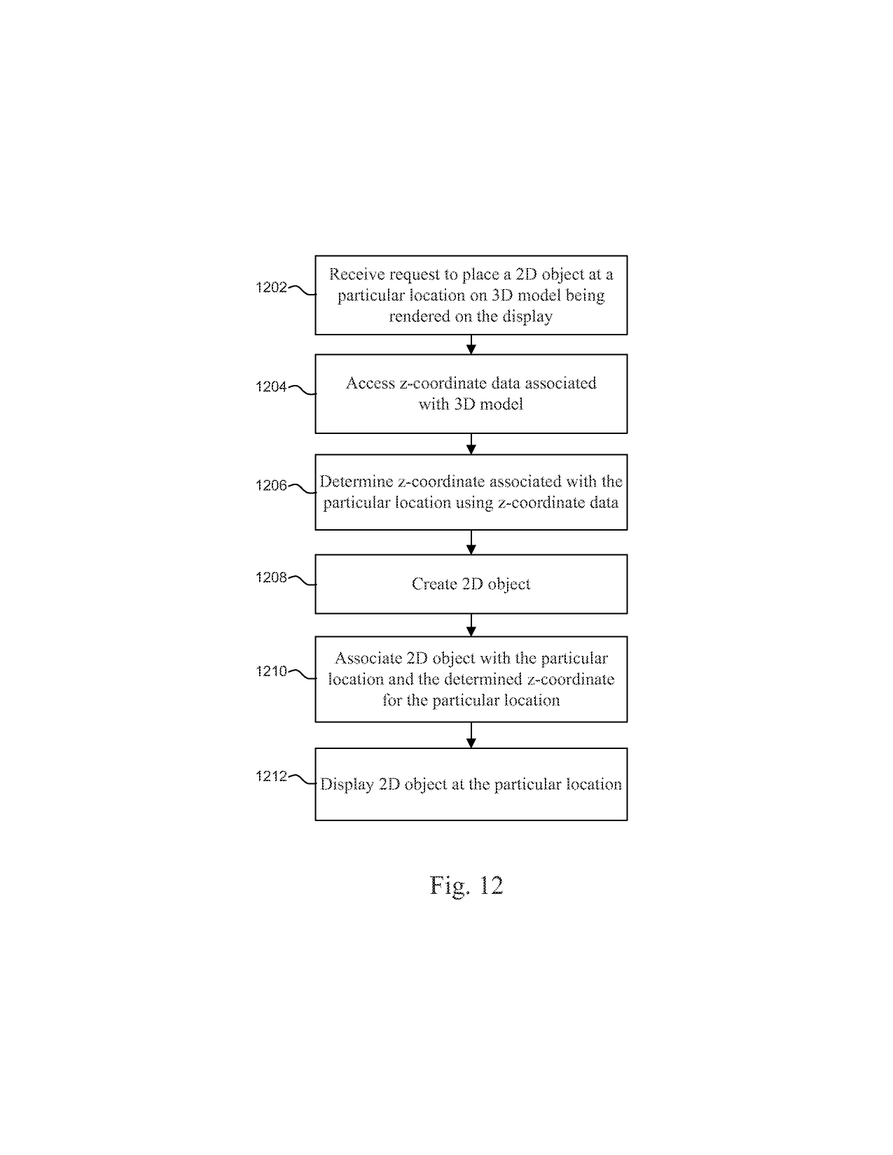

FIG. 12 is a flow chart showing an example method of placing a 2D object on a particular location on the 3D model. As discussed above, a content creator may create a 3D model associated with one or more 2D objects. This content may then be provided to a user for viewing. In some embodiments, a content creator may wish to add an additional 2D object to the already created 3D model. In these cases, the additional 2D object may be added without recreating the 3D model and its association with existing 2D objects.

In operation 1202, a request to place a 2D object at a particular location on the 3D model being rendered on a display may be received. In some embodiments, the request may be received from a content creator. In some embodiments, the request may be received from a user (e.g., to add the user's own annotation to the 3D model).

In operation 1204, z-coordinate data associated with the 3D model being displayed may be accessed. The z-coordinate data may include z-coordinates for each x-y point of the current perspective being displayed. In operation 1206, a z-coordinate associated with the particular x-y location indicated in the request of operation 1202 may be determined from the z-coordinate data.

Using the determined z-coordinate for the particular location indicated in the request, in operation 1208, the requested 2D object may be created. The creation of the 2D object may include creating the content of the 2D object and any display data associated with the 2D object (e.g., arrow directionality preferences, roll, pitch, yaw, scale, etc.).

In operation 1210, the 2D object may be associated with the particular x-y coordinate and the determined z-coordinate for that particular location. Using this information, in operation 1212, the 2D object may be displayed in a manner similar to the operations of FIG. 10.

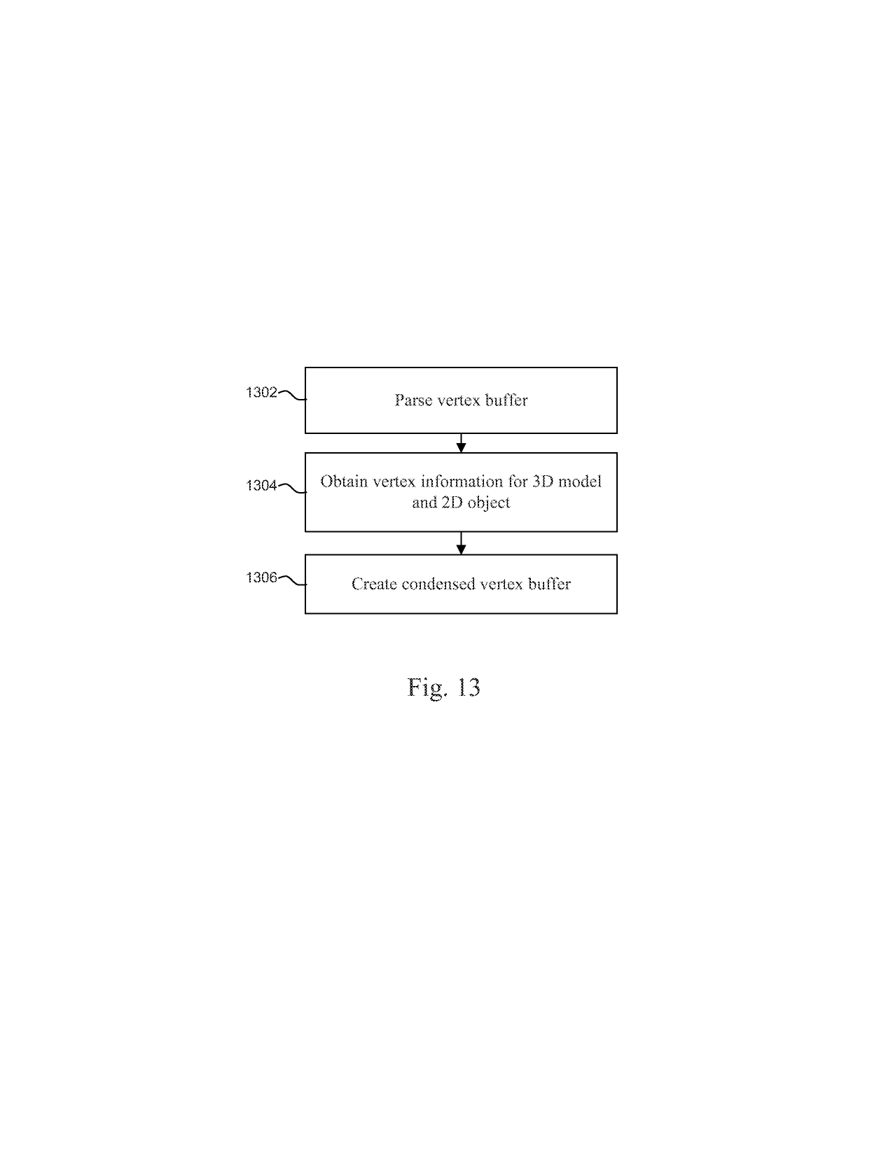

FIG. 13 is a flow chart showing an example method of creating a condensed vertex buffer. In some embodiments, content such as a 3D model may be downloaded and viewed by the user. Some embodiments, the content may be streamed to the user device. In either case, 3D models may have rather large model descriptions, which may cause a 3D model to be rendered slowly in response to a user input. For example, model descriptions may be in human-readable form and may contain human-readable information about the 3D model in addition to vertex information. In these cases, it may be useful to create and use a smaller or condensed vertex buffer for rendering a 3D model. In operation 1302, the original vertex buffer may be parsed in preparation for creating a condensed version of the vertex buffer. In operation 1304, the parsed vertex buffer may be used to obtain at least the minimum data for rendering a 3D model. In some embodiments, this may include the vertex information and information about how the vertices are interconnected for the 3D model and the 2D object, leaving out any superfluous information. In operation 1306, a condensed vertex buffer may be created using the obtained information. The condensed vertex buffer may then be used to more quickly render a 3D model and any associated 2D objects. The condensed vertex buffer may conform to a format that is readily usable by a set of graphics APIs, such as OpenGL ES 2, in which case the condensed vertex buffer allows the graphics system to render the model much more efficiently than would be possible if the model description were left in the original human-readable format.

### Example Machine Implementation

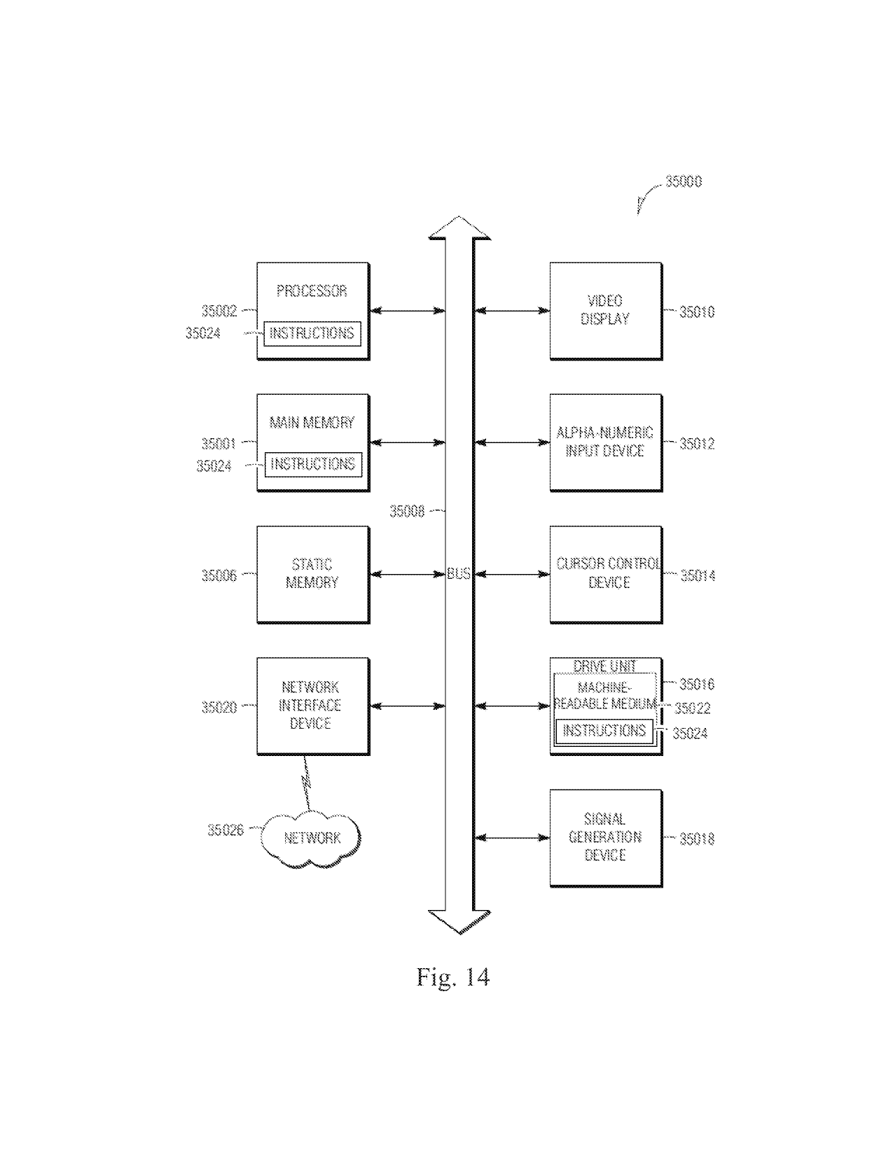

FIG. 14 shows a diagrammatic representation of a machine in the example form of a computer system 35000 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which are linked (e.g., either by hardwired, wireless, or a combination of hardwired and wireless connections) through a network, both perform tasks. In a distributed system environment, program modules may be located in both local and remote memory-storage devices (see below).

The example computer system 35000 includes a processor 35002 a central processing unit (CPU), a graphics processing unit (GPU) or both), a main memory 35001 and a static memory 35006, which communicate with each other via a bus 35008. The computer system 35000 may further include a video display unit 35010 (e.g., a liquid crystal display (LCD) or a cathode ray tube (CRT)). The computer system 35000 also includes an alphanumeric input device 35012 (e.g., a keyboard), a user interface (UI) cursor controller 35014 (e.g., a mouse), a disk drive unit 35016, a signal generation device 35018 (e.g., a speaker) and a network interface device 35020 (e.g., a transmitter).

The disk drive unit 35016 includes a machine-readable medium 35022 on which is stored one or more sets of instructions 35024 and data structures (e.g., software) embodying or used by any one or more of the methodologies or functions illustrated herein. The software may also reside, completely or at least partially, within the main memory 35001 and/or within the processor 35002 during execution thereof by the computer system 35000, the main memory 35001 and the processor 35002 also constituting machine-readable media.

The instructions 35024 may further be transmitted or received over a network 35026 via the network interface device 35020 using any one of a number of well-known transfer protocols (e.g., HTTP, session initiation protocol (SIP)).

The term “machine-readable medium” should be taken to include a single medium or multiple media (e,g., a centralized or distributed database, and/or associated caches and servers) that store the one or more sets of instructions 35024. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium. In some examples the machine-readable medium may be limited to non-transitory machine-readable mediums.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer-readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

### Additional Notes

The above detailed description includes references to the accompanying drawings, which form a part of the detailed description. The drawings show, by way of illustration, specific embodiments in which the technology may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein,” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc, are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the embodiments of the invention should be determined with reference to the appended claims, along with the full scope of equivalents to which such claims are entitled.

What is claimed is:

1. A computer-implemented method comprising:
rendering, using a graphics API via one or more processors, a three-dimensional (3D) model from a first position to a second position on a display of a user device in response to a user input, the 3D model being associated with a two-dimensional (2D) object previously displayed, using native controls via the one or more processors, in the first position prior to the user input;
determining a first set of 3D coordinates associated with the 2D object in the first position;
transforming, via the graphics API, the first set of 3D coordinates associated with the 2D object in the first position to a second set of 3D coordinates associated with the 2D object in the second position based on the user input; and
displaying, via the native controls, the 2D object in the second position based on the second set of 3D coordinates.

2. The computer-implemented method of claim it ; wherein the native controls include controls native to an operating system of the user device.

3. The computer-implemented method of claim 1, wherein the rendering of the 3D model from the first position to the second position includes:
determining a first set of model coordinates associated with the 3D model in the first position;
transforming, via the graphics API, the first set of model coordinates associated with the 3D model in the first position to a second set of model coordinates associated with the 3D model in the second position based on the user input; and
displaying, via the graphics API, the 3D model in the second position based on the second set of model coordinates.

4. The computer-implemented method of claim 1, further comprising:
determining a z-coordinate associated with the 2D object in the second position, wherein displaying the 2D object in the second position includes displaying the 2D object in a faded manner if the z-coordinate is outside a predetermined range.

5. The computer-implemented method of claim 1, further comprising:
changing a left-right arrow directionality of the 2D object in the second position if a product of a first x-coordinate of the 2D object in the first position and a second x-coordinate of the 2D object in the second position is outside a predetermined range.

6. The computer-implemented method of claim l, further comprising:
changing an up-down arrow directionality of the 2D object in the second position if a product of a first y-coordinate of the 2D object in the first position and a second y-coordinate of the 2D object in the second position is outside a predetermined range.

7. The computer-implemented method of claim 1, wherein the user input indicates a resizing of the 2D object, wherein the rendering of the 3D model from the first position to the second position includes changing a scale of the 3D model based on the resizing of the 2D object.

8. The computer-implemented method of claim 1, further comprising:
receiving a request to place a second 2D object at a particular location on the 3D model being rendered in the second position on the display;
accessing z-coordinate data associated with the 3D model in the second position;
determining, using the z-coordinate data, a z-coordinate associated with the particular location on the 3D model being rendered in the second position on the display;
associating the particular location and the z-coordinate with the second 2D object; and
displaying, via the native controls, the second 2D object at the particular location.

9. The computer-implemented method of claim 1, further comprising:
parsing a vertex buffer having information associated with the first position of the 3D model;
obtaining a subset of the information associated with the first position of the 3D model including obtaining vertices associated with the first position of the 3D model; and
creating a second vertex buffer including the subset of information, wherein the rendering the 3D model from the first position to the second position includes rendering using the second vertex buffer.

10. The computer-implemented method of claim 9, wherein the second vertex buffer is used when the 3D model is rendered via an application on the user device.

11. The computer-implemented method of claim 9, wherein the second vertex buffer is used when the 3D model is being rendered via a web browser.

12. A system, comprising:
one or more processors; and
a computer-readable storage medium in communication with the one or more processors, the computer-readable storage medium storing instructions which, when executed by the one or more processors, cause the one or more processors to perform operations, comprising:
rendering, using a graphics API via one or more processors, a 3D model from a first position to a second position on a display of a user device in response to a user input, the 3D model being associated with a 2D object previously displayed, using native controls via the one or more processors, in the first position prior to the user input;
determining a first set of 3D coordinates associated with the 2D object in the first position;
transforming, via the graphics API, the first set of 3D coordinates associated with the 2D object in the first position to a second set of 3D coordinates associated with the 2D object in the second position based on the user input; and
displaying, via the native controls, the 2D object in the second position based on the second set of 3D coordinates.

13. A computer-readable storage medium storing instructions which, when executed by one or more processors, cause the one or more processors to perform operations, comprising:
rendering, using a graphics API via one or more processors, a 3D model from a first position to a second position on a display of a user device in response to a user input, the 3D model being associated with a 2D object previously displayed, using native controls via the one or more processors, in the first position prior to the user input;
determining a first set of 3D coordinates associated with the 2D object in e first position;
transforming, via the graphics API, the first set of 3D coordinates associated with the 2D object in the first position to a second set of 3D coordinates associated with the 2D object in the second position based on the user input; and
displaying, via the native controls, the 2D object in the second position based on the second set of 3D coordinates.

14. The computer-readable storage medium of claim 13, wherein the native controls include controls native to an operating system of the user device.

15. The computer-readable storage medium of claim 13, wherein the rendering of the 3D model from the first position to the second position includes:
determining a first set of model coordinates associated with the 3D model in the first position;
transforming, via the graphics API, the first set of model coordinates associated with the 3D model in the first position to a second set of model coordinates associated with the 3D model in the second position based on the user input; and
displaying, via the graphics API, the 3D model in the second position based on the second set of model coordinates.

16. The computer-readable storage medium of claim 13, the instructions, when executed by the one or more processors, cause the one or more processors to perform the operations further comprising:
determining a z-coordinate associated with the 2D object in the second position, wherein displaying the 2D object in the second position includes displaying the 2D object in a faded manner if the z-coordinate is outside a predetermined range.

17. The computer-readable storage medium of claim 13, the instructions, when executed by the one or more processors, cause the one or more processors to perform the operations further comprising:
changing a left-right arrow directionality of the 2D object in the second position if a product of a first x-coordinate of the 2D object in the first position and a second x-coordinate of the 2D object in the second position is outside a predetermined range.

18. The computer-readable storage medium of claim 13, the instructions, when executed by the one or more processors, cause the one or more processors to perform the operations further comprising:
changing an up-down arrow directionality of the 2D Object in the second position if a product of a first y-coordinate of the 2D object in the first position and a second y-coordinate of the 2D Object in the second position is outside a predetermined range.

19. The computer-readable storage medium of claim 13, wherein the user input indicates a resizing of the 2D object, wherein the rendering the 3D model from the first position to the second position includes changing a scale of the 3D model based on the resizing of the 2D object.

20. The computer-readable storage medium of claim 13, the instructions, when executed by the one or more processors, cause the one or more processors to perform the operations further comprising:
receiving a request to place a second 2D object at a particular location on the 3D model being rendered in the second position on the display;
accessing z-coordinate data associated with the 3D model in the second position;
determining, using the z-coordinate data, a z-coordinate associated with the particular location on the 3D model being rendered in the second position on the display;
associating the particular location and the z-coordinate with the second 2D object; and
displaying, via the native controls, the second 2D object at the particular location.

21. The computer-readable storage medium of claim 13, the instructions, when executed by the one or more processors, cause the one or more processors to perform the operations further comprising:
parsing a vertex buffer having information associated with the first position of the 3D model;
obtaining a subset of the information associated with the first position of the 3D model including obtaining vertices associated with the first position of the 3D model; and
creating a second vertex buffer including the subset of information, wherein the rendering the 3D model from the first position to the second position includes rendering using the second vertex buffer.

22. The computer-readable storage medium of claim 21, wherein the second vertex buffer is used when the 3D model is rendered via an application on the user device.

23. The computer-readable storage medium of claim 21, wherein the second vertex buffer is used when the 3D model is being rendered via a web browser.
